(19) United States
(12) Patent Application Publication
(10) Pub. No.: US 2012/0192829 A1
(43) Pub. Date: Aug. 2, 2012

(54) CRANKLESS ENGINE

(76) Inventor: Jin Hee Choi, Seoul (KR)

(21) Appl. No.: 13/497,882

(22) PCT Filed: Sep. 17, 2010
(86) PCT No.: PCT/KR2010/006385

§ 371 Date: Mar. 23, 2012

(30) Foreign Application Priority Data
Sep. 24, 2009 (KR) 10-2009-0090480

(51) Int. Cl. F02B 75/32

(52) U.S. Cl. 123/197.1

(57) ABSTRACT

An embodiment of the invention relates to a crankless engine capable of reducing the weight and size of the engine without having a crank and connecting rod, and capable of reducing the vibration of the engine by facing two pistons each other.

### TECHNICAL FIELD

The present invention relates to a crankless engine, and more particularly, to the crankless engine capable of reducing the weight and size of an engine without having a crank and connecting rod, offsetting vibration of the engine by facing two pistons each other, and remarkably improving the efficiency of the engine.

### BACKGROUND ART

In general, an engine, which converts heat energy into mechanical work, is used as power source of a transportation machine or an industrial machine. To convert the heat energy into the mechanical work, the engine requires operating material. That is, a gasoline engine uses fuel gas mixed with gasoline and air and combustion gas generated at the time of combusting the fuel gas as the operating material. Further, a diesel engine uses fuel gas mixed with diesel oil and air and combustion gas generated at the time of combusting the fuel gas as the operating material. Further, a stem engine uses water and stem as the operating material.

Meanwhile, a reciprocal piston engine includes cylinder and piston, and has widely been used in a car, a compressor, a generator and a ship etc. in recent.

The reciprocal piston engine, which is an internal combustion, converts explosion energy of the fuel gas into the mechanical work for the piston and crank. That is, the reciprocal piston engine may convert a straight line reciprocal movement of the piston into a rotation movement of the crank by using the crank and connecting rod.

However, in the reciprocal piston engine in the related art, reducing weight of the engine has limits due to the heavy weights of the crank and connecting rod, and reducing the appearance of the engine has limits due to the large appearance of the crank and connecting rod. Therefore, it is very difficult to improve the efficiency and performance of the engine due to the heavy weight and large appearance of the reciprocal piston engine in the related art. In addition, there is disadvantage that is also difficult to secure the space required for disposing the reciprocal piston engine.

Further, it is nearly impossible to change various performance factors of the engine due to a structure connecting the crank, the connecting rod and the piston in the reciprocal piston engine in the related art. Various performance factors are, for example, a maximum compression pressure, a maximum compression point, a fuel explosion point, positions of top dead center and bottom dead center of the piston, and a moving velocity of the piston etc. Therefore, means capable of improving the efficiency and performance of the engine has been limited in the reciprocal piston engine in the related art.

Further, changing opening/closing points and opening/closing time of an intake valve and an exhaust valve have also limits in the reciprocal piston engine in the related art. In recent, although the reciprocal piston engine adjusts some of the operating points of the intake valve and the exhaust valve according to driving environment, the range adjusting it is very narrow. Therefore, according to the driving environment, optimizing intake and exhaust performances has limits in the reciprocal piston engine.

In particular, in recent, the need for the engine having an excellent efficiency and performance is increasing due to various reasons such as depletion of energy, increasing of fuel cost, environment pollution, and various regulations and agreements.

### DISCLOSURE

### Technical Problem

An embodiment of the invention provides a crankless engine capable of remarkably reducing the weight and size of the engine and improving the efficiency and performance of the engine, without having a crank and connecting rod.

Further, the embodiment of the invention provides the crankless engine capable of offsetting variations caused at the time of driving the engine, and therefore, improving the performance of vibration for the engine, by facing two pistons each other.

Further, the embodiment of the invention provides the crankless engine capable of maximizing the efficiency and performance of the engine by conveniently adjusting a maximum compression point, a maximum compression pressure, an opening/closing point and an opening/closing time of the valve, a top dead center and bottom dead center of the piston, and a moving velocity of the piston etc.

### Technical Solution

According to an aspect of the invention, there is provided a crankless engine including a cylinder formed halfway with an intake and exhaust portion disposed with an intake valve and an exhaust valve; a first piston to be reciprocally movable in one side of the cylinder; a second piston to be reciprocally movable in the other side of the cylinder so that the first piston faces the second piston around the intake and exhaust portion; a fuel explosion device, disposed in the intake and exhaust portion, exploding the fuel in the inside of a operating space when the operating space formed among the cylinder, the first piston and the second piston is formed at its minimum; and a rotation drum, disposed in parallel with the cylinder, rotating by moving forces of the first piston and the second piston when the first piston and the second piston reciprocally move.

That is, the first piston and the second piston face each other in the inside of the cylinder around the intake and exhaust portion, and are simultaneously moved toward the intake and exhaust portion or are simultaneously moved in the direction away from the intake and exhaust portion. As above, the crankless engine may be formed by a structure offsetting the vibration caused by the first piston and the second piston. Therefore, the design for the vibration of the crankless engine is omitted, and it is also possible to prevent a harmful influence for the system due to the vibration of the crankless engine.

Further, the crankless engine may be formed by the structure directly converting straight line kinetic energy of the first piston and the second piston into rotation kinetic energy of the rotation drum.

Therefore, the crankless engine does not need the crank and connecting rod used in a reciprocal piston engine in the related art.

The first piston and the second piston may be formed with the guide protrusion protruded toward the rotation drum. One side and the other side of the cylinder may be formed with the guide hole portion through which the guide protrusion is movably penetrated. one side and the other side of the rotation drum may be formed with guide groove portions to be movably inserted with an end portion of the guide protrusion so that the moving forces of the first piston and the second piston are converted into the rotation forces of the rotation drum. Therefore, the first piston and the second piston may be directly connected to the rotation drum by the guide protrusions and the guide groove portions.

The first piston and the second piston may be formed to be not exposed with the guide hole portion in the operating space when the first piston and the second piston move. That is, at the time of driving the crankless engine, the shielding state of the operating space may be always maintained by the cylinder, the first piston and the second piston.

The guide protrusions may be plurally spaced away from each other at random angles along the circumference direction in the outer periphery of the piston. The guide hole portion may be plurally formed in the position facing the guide protrusions. However, the guide groove portions of the rotation drum may be inserted with any one only of the guide protrusions.

The guide hole portion may be formed lengthily in the same width as that of thickness of the guide protrusions along the moving direction of the first piston and the second piston, to guide moving of the first piston and the second piston. Therefore, the guide protrusions and the guide hole portions guide the moving of the first piston and the second piston, and stably support the first piston and the second piston to the cylinder.

The guide groove portions may be formed in at least one looped curve of a sine wave or a deformed sine wave along the circumferential direction in the outer periphery of the rotation drum so that the rotation drum may be rotated by the guide protrusions when the first piston and the second piston reciprocally move. The deformed sine wave is waveform deformed with the portion of the sine wave. Therefore, when the first piston and the second piston reciprocally move along the cylinder, the moving forces of the guide protrusions may be acted to the inclined side of the guide groove portions, and the rotation drum may be rotated in one direction by a component of the forces acted on the side of the guide groove portions. Particularly, when the guide groove portions are formed as the sine wave, the first piston and the second piston may be moved as the same or similar pattern as the reciprocal piston engine in the related art.

The end portion of the guide protrusions may be moved along a single cycle groove portion when one cycle operates in the crankless engine. Further, the guide groove portions may be formed in a shape connecting a plurality of cycle groove portions along the circumference direction in the outer periphery of the rotation drum. Therefore, the crankless engine performs a plurality of operating cycles when the rotation drum 150 rotates once. That is, when adjusting the shape of the guide groove portions, the revolution of the rotation drum rotating per one cycle may be changed in the crankless engine.

Unlike the above, the guide groove portions may be also formed to allow the rotation drum to rotate once or more when one cycle operates in the crankless engine. However, the rotation drum rotates once or more when one cycle operates in the crankless engine, a diameter of the rotation drum becomes very smaller and the rotation velocity of the rotation drum may become very fast.

Variation portions of the guide groove portions may be formed to have large curvatures, respectively, in the range narrower than the variation portions of the sine wave so that the moving directions of the first piston and the second piston rapidly change. The variation portions changing the moving directions of the first piston and the second piston, which are bulging portions above and below in looped curve of a sine wave or a deformed sine wave, are corresponded to the top dead centers and the bottom dead centers of the first piston and the second piston.

Here, since the variation portions of the sine wave are formed in a very gradual curve having small curvatures, the first piston and the second piston may be moved with the very slow velocity in the section changing the moving directions, and therefore, time required for changing the moving directions of the first piston and the second piston may be also increased. Therefore, a frequency to allow the first piston 120 and the second piston 130 to reciprocally move per unit time is decreased, such that the efficiency of the usage may be lowered.

On the other hand, in the present embodiment, since the variation portions of the guide groove portions are formed in a sharp curve having large curvatures, the first piston and the second piston may be moved with the very fast velocity in the section changing the moving directions, and therefore, time required for changing the moving directions of the first piston and the second piston may be shortened. Therefore, the frequency to allow the first piston and the second piston to reciprocally move per unit time is relatively increased, such that efficiency of the usage may be improved, one cycle period may be also shortened in the crankless engine.

When the crankless engine is one cycle engine with four strokes, each of the variation portions of the guide groove portions may be formed in positions different from each other so that the operating space is formed at its maximum in a intake stroke and the operating space is formed at its minimum in a exhaust stroke. That is, the positions of the variation portions corresponding to the bottom dead centers of the intake stroke among the variation portions of the guide groove portions may be disposed more away from the intake and exhaust portion, and the positions of the variation portions corresponding to the top dead centers of the exhaust stroke among the variation portions of the guide groove portions may be disposed closer to the intake and exhaust portion.

Therefore, since the operating space is increased at its maximum in the intake stroke, the intake amount of the fuel or air is increased, thereby to improve the intake efficiency.

The maximum compression pressure of the compression stroke may be increased by increasing the intake amount, thereby to increase the efficiency of the engine. Further, since the operating space is decreased at its minimum in the exhaust stroke, the remaining amount of the exhaust gas is decreased, thereby to improve the exhaust efficiency.

The guide groove portions may be formed so that, at the time of operating the fuel explosion apparatus, an angle between a tangent line of the surface contacting the guide protrusions and the moving direction of the guide protrusions is formed from 0 to 50 degree. Of course, an angle between a tangent line of the surface contacting the guide protrusions and the moving direction of the guide protrusions may be also formed from 50 to 90 degree according to design conditions and situations of the engine. However, when the angle between the tangent line of the guide groove portions and the moving direction of the guide protrusions is approaching 90 degree, the guide groove portions are likely to hinder the moving of the guide protrusions. On the other hand, when the angle between the tangent line of the guide groove portions and the moving direction of the guide protrusions is approaching 0 degree, the guide protrusions may be smoothly moved at high velocity along the guide groove portions at the time of operating the fuel explosion device.

The inside of the intake and exhaust portion may be formed in a hollow shape. The inside of the intake and exhaust portion may be formed may be formed by the sectional area smaller than those of the cylinder. Therefore, needless increase of the operating space may be prevented, and the maximum compression pressure may be also increased by the first piston and the second piston.

The fuel explosion device may include a fuel injection device injecting fuel gas into the inside of the operating space at the point that the size of the operating space is at its minimum. Here, at the point that the size of the operating space is at its minimum, the air in the operating space may be compressed to be a temperature naturally igniting the fuel gas. Unlike the above, the fuel explosion device may include a fuel ignition device igniting fuel gas in the inside of the operating space at the point that the size of the operating space is at its minimum. Here, at the point that the size of the operating space is at its minimum, the fuel gas and air in the operating space may be compressed to be a pressure perfectly combusting the fuel gas.

The inside of the rotation drum may be formed in a hollow shape. The insides of the rotation drum may be disposed with a transmission power portion powering to the outside after transmitting the rotation forces of the rotation drum. That is, the transmission power portion is a transmission device accelerating or decelerating the rotation forces of the rotation drum at a desired velocity and powering to the outside after transmitting the rotation forces of the rotation drum. For example, the transmission power portion may be formed as a planetary gear set decelerating the rotation forces of the rotation drum. However, the transmission power portion is not limited to the planetary gear set, and the transmission device having various structures capable of accelerating and decelerating the rotation forces of the rotation drum may be used.

Further, the rotation drum may be formed so that the length thereof may be adjusted in the axis direction, so as to change the position of the guide groove portions. As above, when the length of the rotation drum is adjusted in the axis direction, the positions of the guide groove portions are changed, and therefore, the position of the first piston and the second piston may be also changed. For example, when the length of the rotation drum becomes short, a gap between the first piston and the second piston is reduced, thereby to reduce the size of the operating space. On the other hand, when the length of the rotation drum becomes large, a gap between the first piston and the second piston is increased, thereby to increase the size of the operating space. Therefore, the performance of the crankless engine may be effectively changed by adjusting the length of the rotation drum.

The cylinders are formed to be spaced away from each other at random intervals plurally along circumferential direction in an outer periphery of the rotation drum. Therefore, the first piston, the second piston and the fuel explosion device may be disposed in each of the cylinders. Like this, since the cylinders, the first pistons, and the second pistons are disposed together in a single rotation drum, the rotation drum may be commonly used, and the number of the cylinder for the engine may be increased while relatively greatly not increasing the size of the appearance thereof.

The guide groove portions may be formed by the same number as that of the cylinders. The rotation drum may be formed with the guide groove portions connecting with each other along the circumferential direction thereof. So then, the first piston and the second piston perform the same stroke regardless of their positions.

Unlike the above, the guide groove portions may be formed by the number larger or smaller than that of the cylinders. In addition, the rotation drum may be formed with the guide groove portions connecting with each other along the circumferential direction thereof. So then, the first piston and the second piston perform the stroke different from each other according to their positions.

The above described cylinders may be disposed in a plurality of positions along the length direction of the rotation drum. Further, each of the guide groove portions may be formed in the outer periphery of the rotation drum corresponding to the cylinders. That is, since the cylinders, the first pistons, and the second pistons may be disposed in the positions to be spaced apart from each other in the length direction of the rotation drum, the number of the cylinder for the engine may be simply increased.

According to another aspect of the invention, there is provided a crankless engine including a cylinder formed at one side with an intake and exhaust portion disposed with an intake valve and an exhaust valve; a piston to be reciprocally movable in the other side of the cylinder; a fuel explosion apparatus, disposed in the intake and exhaust portion, exploding the fuel in the inside of an operating space when the operating space formed between the piston and the cylinder is formed at its minimum; and a rotation drum, disposed in parallel with the cylinder, rotating by moving forces of at least one piston when the piston reciprocally moves.

That is, Unlike the crankless engines according to an embodiment of the invention as described above, it is different to include a single piston only in the cylineder of the crankless engines according to another embodiment of the invention, the elements except it may be configured the same or similar as an embodiment of the invention. Further, it is described that the crankless engine in another embodiment of the invention includes a single or two pistons in the cylinder, but it is not limited thereto and three or more pistons may be disposed in the cylinder according to the design conditions and situations of the engine.

The crankless engine in the embodiment of the invention is disposed in the cylinder or an engine case, and may further include a valve opening/closing device adjusting opening/closing of the intake valve and the exhaust valve according the rotational angle of the rotation drum. That is, the valve opening/closing device may automatically open/close the exhaust valve and the intake valve using the rotation forces of the rotation drum. Therefore, a timing belt and a cam axis etc. used in the reciprocal piston engine in the related art are unnecessary.

The valve opening/closing device includes a drum protrusion portion protruded from the outer periphery of the rotation drum, a valve opening/closing portion rotatably disposed in the outside of the cylinder or the engine case and disposing one side thereof in the end portion of the exhaust valve or the end portion of the intake valve, and an opening/closing adjustment portion disposed between the other side of the valve opening/closing portion and the drum protrusion portion and opening/closing the intake valve or the exhaust valve by rotating the valve opening/closing portion at the time of rotating the rotation drum.

At least one of the valve opening/closing portion or the opening/closing adjustment portion may be disposed, so that the position thereof may be changed in the cylinder or the engine case, so as to adjust opening/closing point of the intake valve and the exhaust valve. Therefore, when using the crankless engine for a long time, in a case where timing of the intake valve deviates from that of the exhaust valve, the timing of the intake valve and the exhaust valve may be simply adjusted by changing the position of the rotation axis of the valve opening/closing portion.

The drum protrusion portion includes an intake drum protrusion portion and an exhaust drum protrusion portion disposed in positions different from the each other in the rotation drum. At this time, the intake drum protrusion portion and the exhaust drum protrusion portion may be formed plurally along circumferential direction in an outer periphery of the rotation drum. That is, the intake valve may be opened/closed by the intake drum protrusion portion, and the exhaust valve may be opened/closed by the exhaust drum protrusion portion.

The opening/closing adjustment portion may be formed as an opening/closing adjustment protrusion protruded from the other side of the valve opening/closing portion so that the end portion thereof rotatably contacts the outer periphery of the rotation drum formed with the drum protrusion portion at the time of rotating the rotation drum. That is, the opening/closing adjustment protrusion may be rotated in the radius direction of the rotation drum by the drum protrusion portion at the time of rotating the rotation drum, and the valve opening/closing portion may be rotated together with the opening/closing adjustment protrusion.

Further, the opening/closing adjustment portion may include a moving guide disposed between the valve opening/closing portion and the rotation drum, and an opening/closing adjustment rod disposed movably with respect to the moving guide and disposing both ends thereof in the other side of the valve opening/closing portion and the outer periphery of the rotation drum. That is, the opening/closing adjustment rod may be moved in the radius direction of the rotation drum along the moving guide by the drum protrusion portion at the time of rotating the rotation drum, and the valve opening/closing portion may be rotated by the opening/closing adjustment rod.

Meanwhile, unlike the above, the drum protrusion portion may include an intake drum protrusion portion and an exhaust drum protrusion portion disposed in positions different from each other in the rotation drum. At this time, the intake drum protrusion portion and the exhaust drum protrusion portion may be formed in a gear shape along circumferential direction in the outer periphery of the rotation drum. That is, the intake valve may be opened/closed by the intake drum protrusion portion, and the exhaust valve may be opened/closed by the exhaust drum protrusion portion.

The opening/closing adjustment portion may include a cam gear coupled with the drum protrusion portion, and an opening/closing adjustment cam disposed in the rotation axis of the cam gear and slidably contacting in the other side of the valve opening/closing portion That is, when rotating the rotation drum, the cam gear may be rotated together with the drum protrusion portion, the opening/closing adjustment cam may be rotated together with the cam gear, and the valve opening/closing portion may be rotated by the opening/closing adjustment cam.

### Advantageous Effects

In the crankless engine, without having a crank and connecting rod, according to embodiment of the invention, the weight and size of the engine may be remarkably reduced. In addition, in the crankless engine according to the invention, the efficiency and performance of the engine may be improved by reducing the weight and size of the engine.

Further, in the crankless engine according to the embodiment of the invention, vibrations caused at the time of driving the engine may be offset by facing two pistons each other. Therefore, in the crankless engine of the invention, vibration amounts to be generated may be remarkably reduced, and therefore, the need of design for the vibration and a harmful influence of the vibration may be reduced.

Further, in the crankless engine according to the embodiment of the invention, the performance and efficiency of the engine may be improved by changing the shape of the guide groove portions formed in the rotation drum. That is, in the crankless engine of the invention, a maximum compression point and maximum compression pressure of the engine, an opening/closing point and an opening/closing time of the valve, a top dead center and bottom dead center of the piston, and a moving velocity of the piston etc may be conveniently adjusted by changing the shape of the guide groove portions.

In addition, in the crankless engine according to an embodiment of the invention, since the cylinders, the first pistons, and the second pistons are disposed in a single rotation drum, the number of the cylinder for the engine may be conveniently increased/decreased. In addition, since the crankless engine of the invention uses a single rotation drum only regardless of the numbers of the cylinders, the first pistons and the second pistons, the change of the size for the appearance of the engine due to the increasing of the number of the cylinder is small, and therefore, it is possible to manufacture a high power engine having a very small size.

### DESCRIPTION OF DRAWINGS

FIG. 1 is a front view shown with a crankless engine according to an embodiment of the invention.

FIG. 2 is a view showing section taken by line I-I of FIG. 1.

FIG. 3 is a view representing guide hole portions of a cylinder shown in FIG. 1.

FIGS. 4 to 7 are operating state views representing an intake stroke, a compression stroke, an expansion stroke, and an exhaust stroke of the crankless engine shown in FIG. 1, respectively.

FIGS. 8 to 12 are views representing various examples of guide groove portions shown in FIG. 1 in a shape spread with a rotation drum, respectively.

FIG. 13 is an operating state view representing one example of a valve opening/closing device shown in FIG. 2.

FIGS. 14 to 16 are operating state views representing another example of the valve opening/closing device shown in FIG. 13, respectively.

FIG. 17 is a front view shown with the crankless engine according to another embodiment of the invention.

FIG. 18 is a view representing a section of the crankless engine showed in FIG. 17.

FIG. 19A-19I are a schematic view representing various structures of the guide groove portions according to the number of the cylinder in another embodiment of the invention.

FIG. 20 is a front view shown with the crankless engine according to another embodiment of the invention.

FIG. 21 is a front view shown with the crankless engine according to another embodiment of the invention.

### MODE FOR INVENTION

Hereinafter, the embodiments according to the invention will be described in detail with reference to the attached drawings. However, the invention is not limited to or defined as the embodiments. Like reference numerals refer to like elements.

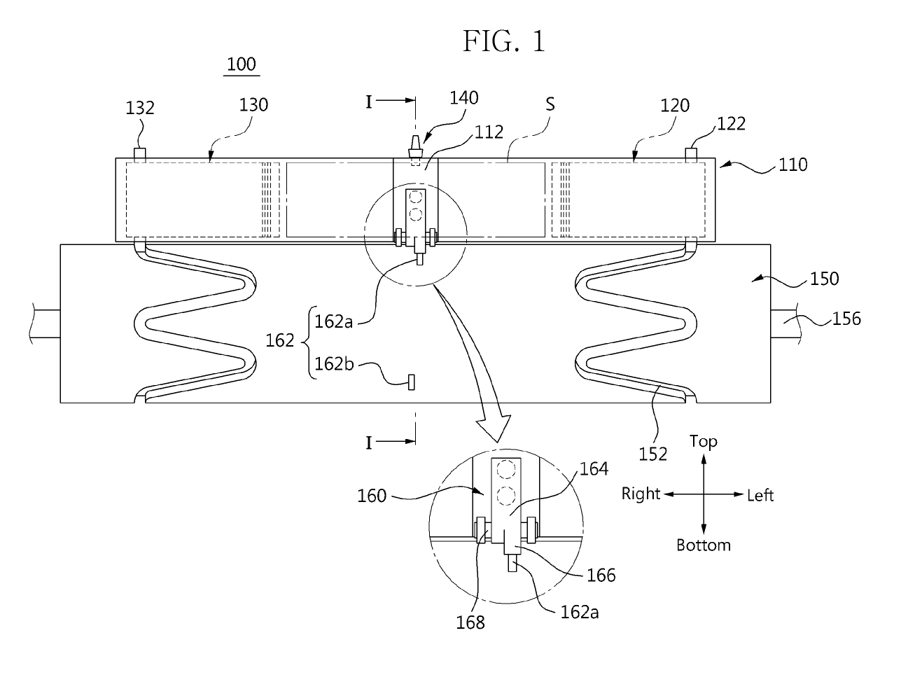

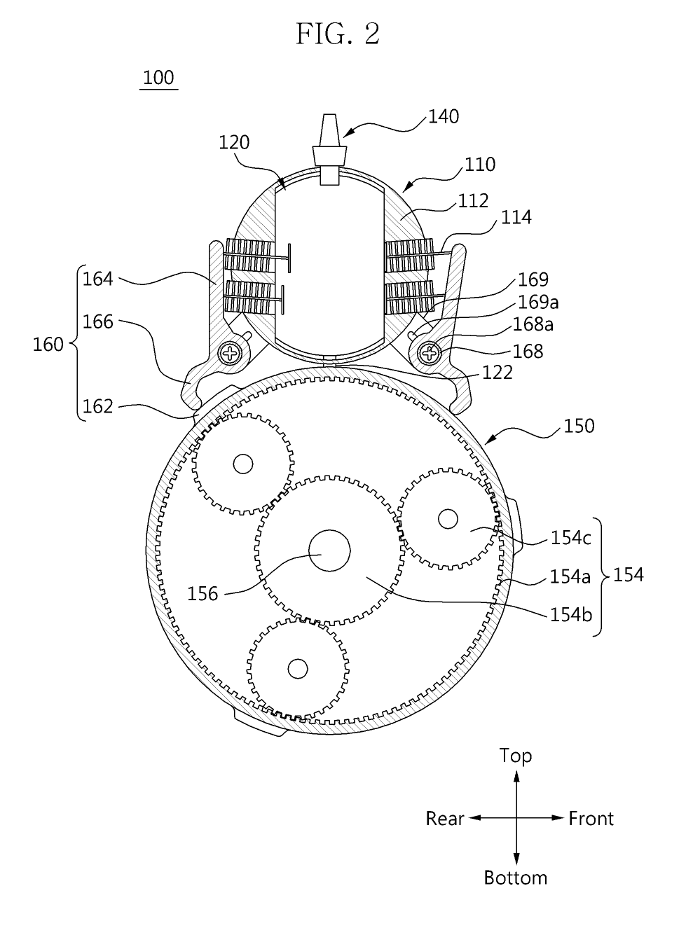

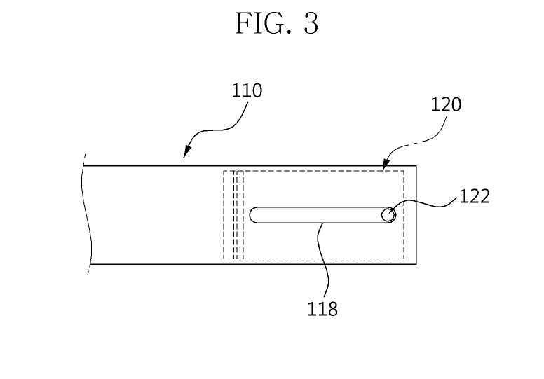

FIG. 1 is a front view shown with a crankless engine according to an embodiment of the invention, FIG. 2 is a view showing section taken by line I-I of FIG. 1, and FIG. 3 is a view representing guide hole portions of a cylinder shown in FIG. 1.

Referring to FIG. 1, according to an embodiment of the invention, the crankless engine(100) includes a cylinder 110, a first piston 120, a second piston 130, and a fuel explosion device 140, a rotation drum 150, and a valve opening/closing device 160. Here, the insides of the cylinder 110, the first piston 120, and the second piston 130 are formed with an operating space S. The operating space S accommodates fuel and air. As the first piston 120 and the second piston 130 move, volume of the operating space S may be changed.

Referring to FIGS. 1 and 2, the inside of the cylinder 110 is a member having a hollow barrel shape. The left and right portion of the cylinder 110 may be disposed with the first piston 120 and the second piston 130 to be movably disposed in left and right directions. The midsection of the cylinder 110 may be formed with an intake and exhaust portion 112 disposed with an intake valve 114 and an exhaust valve 116.

The inside of the intake and exhaust portion 112 may be formed in a hollow shape. The inside of the intake and exhaust portion 112 may be formed by the sectional area smaller than those of the inside of the cylinder 110.

Because, needless increase of the operating space S due to the inside space of the intake and exhaust portion 112 may be prevented. So, the maximum compression pressure for the operating space S may be also increased by the first piston 120 and the second piston 130.

The intake and exhaust portion 112 may be disposed with a single or a plurality of intake valve 114 and the exhaust valve 116 in various positions. Hereinafter, it is described in the present embodiment that two intake valves 114 are disposed in the front of the intake and exhaust portion 112 and two exhaust valves 116 are disposed at the back of the intake and exhaust portion 112.

Referring to FIGS. 1 to 3, the first piston 120 may be disposed to be reciprocally movable in the left portion of the cylinder 110, and the second piston 130 may be disposed to be reciprocally movable in the right portion of the cylinder 110. The first piston 120 and the second piston 130 may be disposed to be bilaterally symmetric around the intake and exhaust portion 112 of the cylinder 110, and may be operated in the direction to be symmetric from each other at the time of operating the crankless engine 100. That is, The first piston 120 and the second piston 130 may be faced each other around the intake and exhaust portion 112, and may be simultaneously moved toward the intake and exhaust portion 112 or may be simultaneously moved in the direction away from the intake and exhaust portion 112.

Therefore, since vibration caused by the first piston 120 and vibration caused by the second piston 130 are in the opposite direction, vibrations of the first piston 120 and the second piston 130 may be offset. Like this, the crankless engine 100 is formed as a structure offsetting vibrations of the first piston 120 and the second piston 130, thereby to greatly reduce difficulty of design due to the vibration and to prevent a harmful influence for the engine due to the vibration.

The outer periphery of the first piston 120 and the second piston 130 may be formed with guide protrusions 122 and 132 to be protruded in a radius direction. The guide protrusions 122 and 132 may be spaced away from each other plurally at random angles along the circumference direction in the outer periphery of the first piston 120 and the second piston 130. Hereinafter, it is described in the present embodiment that the outer periphery of the first piston 120 and the second piston 130 are formed with two guide protrusions 122 and 132.

In addition, the left and right portion of the cylinder 110 may be formed with guide hole portions 118, respectively, through which the guide protrusions 122 and 132 are movably penetrated. The guide hole portions 118 may be formed plurally in the positions facing the guide protrusions 122 and 132. The guide hole portions 118 may be formed lengthily in the same width as that of the thickness of the guide protrusion 122 and 132 along the moving direction of the first piston 120 and the second piston 130. Thus, the guide protrusion 122 and 132 and the guide hole portion 118 guides the moving of the first piston 120 and the second piston 130, and stably support the first piston 120 and the second piston 130 to the cylinder.

At the time of driving the crankless engine 100, the first piston 120 and the second piston 130 may be formed so that the guide hole portion 118 is not exposed between the first piston 120 and the second piston 130. That is, when the portion of the guide hole portion is exposed between the first piston 120 and the second piston 130, a shielding state of the operating space S is destroyed, thereby to greatly reduce performance and efficiency of the crankless engine 100. Therefore, the shapes of the first piston 120 and the second piston 130 are made by the design always maintaining the shielding state of the operating space S at the time of driving the crankless engine 100.

Referring to FIGS. 1 and 2, the fuel explosion device 140 explodes the fuel in the inside of the operating space when the operating space S is at its minimum. The fuel explosion device 140 may be disposed in the intake and exhaust portion 112. The position and the number of the fuel explosion device 140 are not limited to the present invention, and a single or a plurality of the fuel explosion device 140 may be disposed in various positions of the cylinder 110 as necessary.

When the crankless engine 100 is a diesel engine, the fuel explosion device 140 may include a fuel injection device(not shown) injecting fuel gas into the inside of the operating space S at the time that the size of the operating space S is at its minimum. At the time that the size of the operating space S is at its minimum, the air in the operating space is compressed to be a temperature naturally igniting the fuel gas by the first piston 120 and the second piston 130.

Further, when the crankless engine 100 is a gasoline engine, the fuel explosion device 140 may include a fuel ignition device igniting fuel gas in the operating space S at the time that the size of the operating space S is at its minimum. At the time that the size of the operating space S is at its minimum, the air in the operating space S is compressed to be a pressure perfectly combusting the fuel gas by the first piston 120 and the second piston 130.

Hereinafter, it is described in the present embodiment that the crankless engine 100 is the gasoline engine, and the fuel explosion device includes the fuel ignition device. Further, it is described in the present embodiment that the crankless engine 100 is one cycle engine with four strokes consisting of an intake stroke, a compression stroke, an expansion stroke, and an exhaust stroke.

Referring to FIGS. 1 and 2, the rotation drum 150 receives straight line kinetic energy of the first piston 120 and the second piston 130 at the time of driving the crankless engine 100, and switches the received energy into rotation kinetic energy. Therefore, in the crankless engine 100 of the present embodiment, since the rotation drum 150 serves as a crank used in a reciprocal piston engine in the related art, such that the crank and a connecting rod are unnecessary.

The rotation drum 150 may be disposed in parallel with the cylinder 110 in the position adjacent to the cylinder 110. The left and right portion of the rotation drum 150 may be formed with the guide groove portions 152 into which the end portions of the guide protrusions 122 and 132 penetrating through the guide hole portions 118 are movably inserted. The guide groove portions 152 may be inserted with any one only of the guide protrusions 122 and 132 of the first piston 120 and the second piston 130. Therefore, the first piston 120 and the second piston 130 are directly connected to rotation drum 150 through the guide protrusions 122 and 132 and the guide groove portions 152.

Meanwhile, the inside of the rotation drum 150 may be formed in a hollow barrel shape. The insides of the rotation drum 150 may be disposed with a transmission power portion 154 powering to the outside after transmitting the rotation forces F of the rotation drum 150. That is, the transmission power portion 154 is a transmission device accelerating or decelerating the rotation forces F of the rotation drum 150 at a desired velocity.

For example, the transmission power portion 154 may be formed with the planetary gear set decelerating the rotation forces F of the rotation drum 150. That is, an inner periphery of the rotation drum 150 may be mounted with a ring gear 154a, the center of the hollow portion of the rotation drum 150 may be mounted with a sun gear 154b, and a plurality of planetary gear 154c may be disposed between the ring gear 154a, and the sun gear 154b. The ring gear 154a may be rotated with the same velocity as that of the rotation drum 150, and the planetary gears 154c are connected by a carrier (not shown). Therefore, when fixing any one of the sun gear 154b and the planetary gears 154c and connecting the other one of the sun gear 154b and the planetary gears 154c to a power axis 156, the rotation forces F powered to the power axis 156 may have the rotation velocity lower than that of the ring gear 154a.

However, the transmission power portion 154 is not limited to the planetary gear set, and the transmission device having various structures capable of accelerating and decelerating the rotation forces F of the rotation drum 150 may be used.

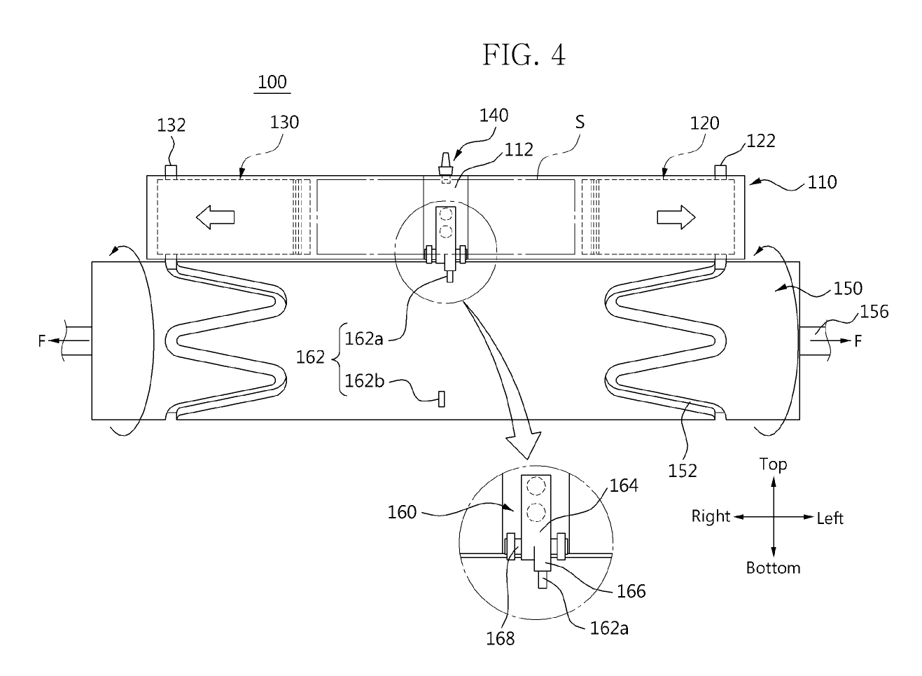

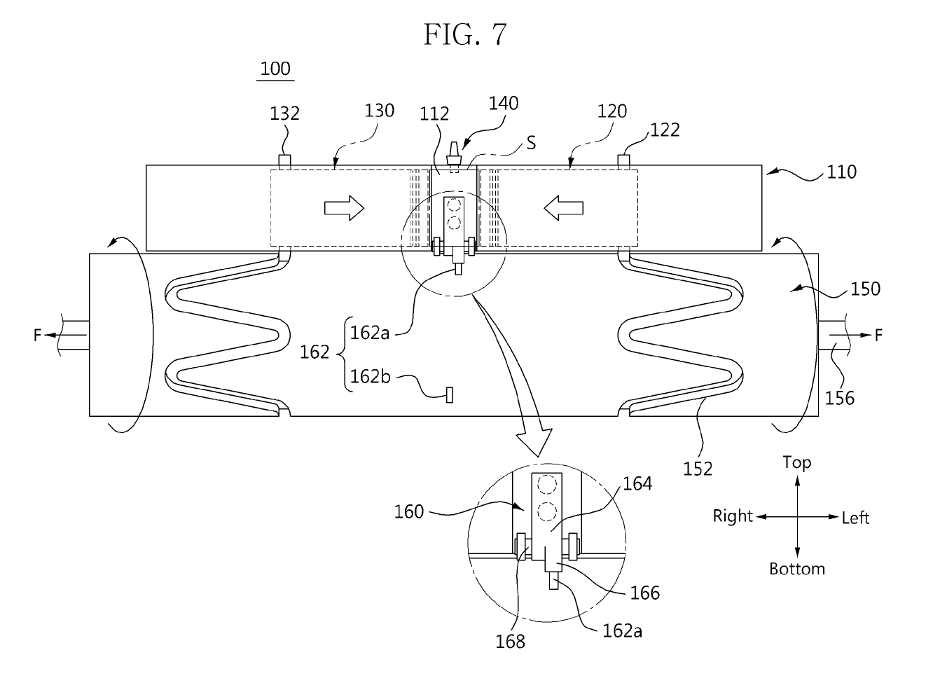

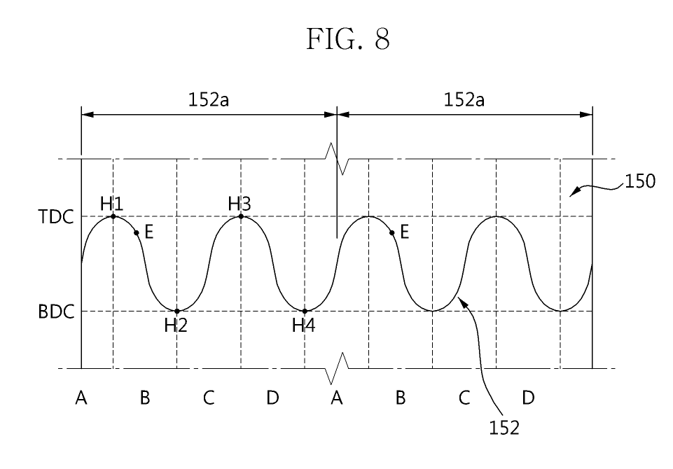

FIGS. 4 to 7 are operating state views representing the intake stroke, the compression stroke, the expansion stroke, and the exhaust stroke of the crankless engine shown in FIG. 1, respectively. FIGS. 8 to 12 are views representing various examples of the guide groove portions shown in FIG. 1 in the shape spread with a rotation drum, respectively.

Referring to FIGS. 4 to 8, the moving forces of the first piston 120 and the second piston 130 are switched into the rotation forces F of the rotation drum 150 by the shape of the guide groove portions 152 of the present embodiment. For example, the guide groove portions 152 may be formed in at least one looped curve of a sine wave or a deformed sine wave along the circumferential direction in the outer periphery of the rotation drum 150. The deformed sine wave is waveform deformed with the portion of the sine wave.

As shown in FIG. 8, when the guide groove portions 152 are formed as the sine wave, the first piston 120 and the second piston 130 may be moved as the same or similar pattern as that of the reciprocal piston engine in the related art, and may be moved as the same or similar stroke as that of the reciprocal piston engine in the related art. In addition, when the first piston 120 and the second piston 130 are reciprocally moved along the cylinder 110, the guide protrusions 122 and 132 may be moved along the guide groove portions 152, and the moving forces of the guide protrusions 122 and 132 may be acted on an inclined side of the guide groove portions 152. Like this, the rotation drum 150 may be rotated by a component of the forces acted on the side of the guide groove portions 152.

The guide groove portions 152 may be formed in the shape connecting cycle groove portions 152a along the circumference direction in the outer periphery of the rotation drum 150. Here, the cycle groove portions 152a are groove portions formed in the shape corresponding to paths to allow the end portions of the guide protrusions 122 and 132 to move when one cycle operates in the crankless engine 100. As above, when the guide groove portions 152 are formed as the structure connecting a plurality of cycle groove portions 152a, the crankless engine 100 may perform a plurality of operating cycles at the time of once rotating the rotation drum 150. Therefore, when adjusting the number of the cycle groove portions 152a forming the guide groove portion 152, the revolution of the rotation drum 150 rotating per one operating cycle of the crankless engine 100 may be changed.

Unlike the above, the guide groove portion 152 may be also formed to allow the rotation drum 150 to rotate once or more when one cycle operates in the crankless engine 100. However, when the rotation drum 150 rotates once or more on operating one cycle in the crankless engine 100, the diameter of the rotation drum 150 should be extremely reduced, and the rotation velocity of the rotation drum 150 also becomes too fast more than needs. Hereinafter, it is described in the present embodiment that the guide groove portions 152 are formed in a shape performing a plurality of operating cycles by the crankless engine 100 at the time of once rotating the rotation drum 150.

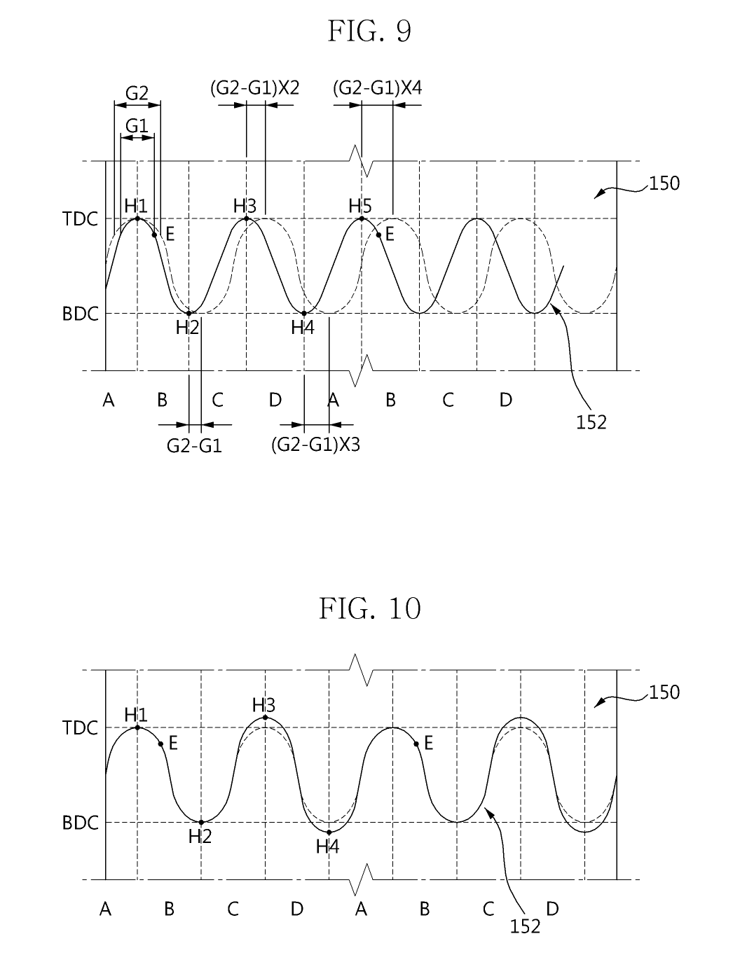

Meanwhile, FIG. 9 shows another example of the guide groove portions 152. In FIG. 9, variation portions H1, H2, H3, and H4 of the guide groove portions 152 may be formed to have large curvatures, respectively, in the range narrower than that of the variation portions H1, H2, H3, and H4 of the sine wave. The moving direction of the first piston 120 and the second piston 130 are changed in the variation portions H1, H2, H3, and H4. That is, the variation portions H1, H2, H3, and H4 are bulging portions above and below, and are corresponded to the top dead centers(TDC) and the bottom dead centers(BDC) of the first piston 120 and the second piston 130. The top dead centers(TDC) of the first piston 120 and the second piston 130 are the positions for the first piston 120 and the second piston 130 to be moved nearest the intake and exhaust portion 112, and the bottom dead centers(BDC) of the first piston 120 and the second piston 130 are the positions for the first piston 120 and the second piston 130 to be moved farthest the intake and exhaust portion 112.

The variation portions H1, H2, H3, and H4 of the guide groove portions 152 shown in FIG. 8 are formed in the shape of a very gradual curve having small curvatures. Therefore, the moving directions of the first piston 120 and the second piston 130 may be changed with the very slow velocity. As a result, since time G2 required for changing the moving directions of the first piston 120 and the second piston 130 is also greatly increased, a usage efficiency of the first piston 120 and the second piston 130 may be reduced.

On the other hand, the variation portions H1, H2, H3, and H4 of the guide groove portions 152 shown in FIG. 9 are formed in the shapes of sharp curves having great curvatures. Therefore, the moving directions of the first piston 120 and the second piston 130 may be changed with very fast velocity. As a result, since time G1 required for changing the moving directions of the first piston 120 and the second piston 130 is also shortened by a predetermined time (G2−G1), the moving number per unit time for the first piston 120 and the second piston 130 may be increased, such that the usage frequency of the first piston 120 and the second piston 130 may be increased. Further, as shown in FIG. 9, one cycle period (H1˜H5) in the crankless engine 100 may be also reduced by ‘(G2−G1)*4’. On describing in detail, time of ‘G2−G1’ is shortened, respectively, in the section of H1˜H2, the section of H2˜H3, the section of H3˜H4, and the section of H4˜H5, and therefore, starting point of H5 may be also shortened by ‘(G2−G1)*4’ than in the related art.

Further, FIG. 10 shows another example of the guide groove portions 152. In FIG. 10, the variation portions H1, H2, H3, and H4 of the guide groove portions 152 may be formed in the positions different from each other, respectively. That is, the variation portion H3 formed between the exhaust stroke C and the intake stroke D may be formed to be higher, in the direction of the top dead center, than the variation portion H1 formed between the compression stroke A and the expansion stroke B, and the variation portion H4 formed between the intake stroke D and the compression stroke A may be formed to be lower, in the direction of the bottom dead center, than the variation portion H2 formed between the expansion stroke B and the exhaust stroke C.

When the variation portion H3 corresponding to the top dead center of the exhaust stroke C is formed to be higher, the exhaust gas is perfectly exhausted due to the difference in the height thereof, thereby to improve the exhaust efficiency of the engine. Further, when the variation portion H4 corresponding to the bottom dead center of the intake stroke D is formed to be lower, an intake amount of the fuel gas is increased due to the difference in the height thereof, thereby to improve the intake efficiency of the engine. Particularly, when the intake amount of the fuel is increased in the intake stroke D, the maximum compression pressure of the compression stroke A is increased, and the fuel gas is perfectly combusted, thereby to improve the efficiency of the engine.

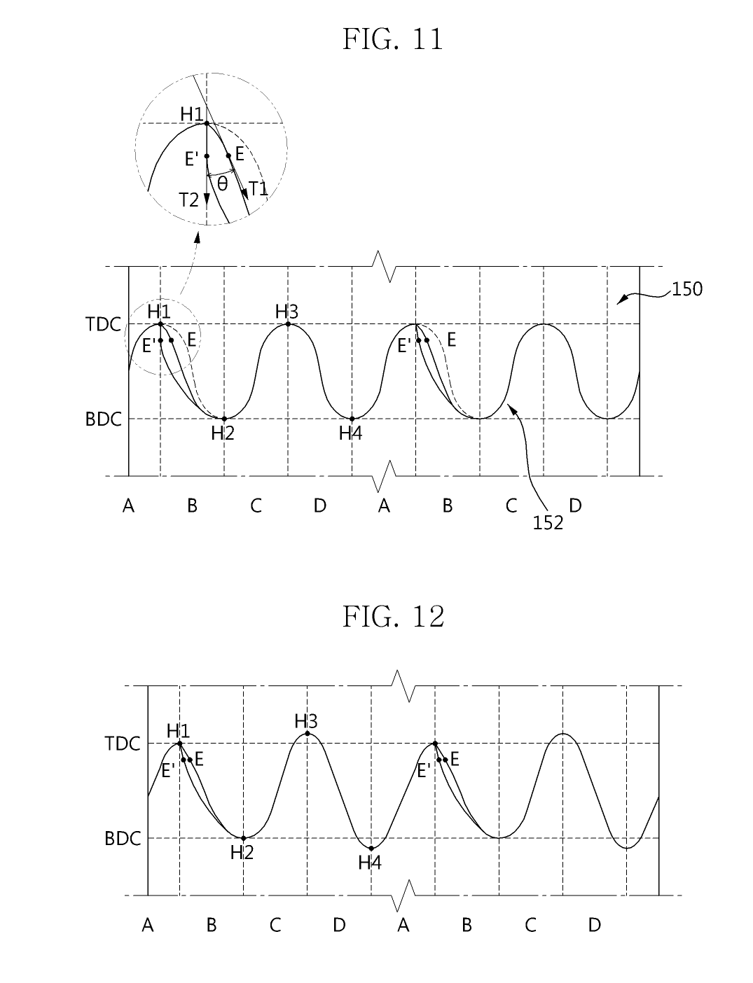

Further, FIG. 11 shows another example of the guide groove portions 152. In FIG. 11, the variation portions H1, H2, H3, and H4 of the guide groove portions 152 may be formed the same or similar as the guide groove portions 152 shown in FIG. 8, respectively. However, the guide groove portions 152 in FIG. 11 is formed so that, at the point E and E′ of operating the fuel explosion apparatus 140, an angle θ between a tangent line T1 of the guide groove portions 152 and the moving direction T2 of the guide protrusions 122 and 132 may be formed from 0 to 50 degree. Of course, at the point E and E′ of operating the fuel explosion apparatus 140, an angle θ between the tangent line T1 of the guide groove portions 152 and the moving direction T2 of the guide protrusions 122 and 132 may be formed from 0 to 90 degree according to the design conditions and situations of the engine. However, when the angle θ between the tangent line T1 of the guide groove portions 152 and the moving direction T2 of the guide protrusions 122 and 132 is approaching 90 degree, the guide groove portions 152 are likely to hinder the moving of the guide protrusions 122 and 132. Therefore, it is described in the present embodiment that the angle θ between the tangent line T1 of the guide groove portions 152 and the moving direction T2 of the guide protrusions 122 and 132 is approaching 0 degree.

Like this, at the point E and E′ of operating the fuel explosion apparatus 140, when the angle θ between the tangent line T1 of the guide groove portions 152 and the moving direction T2 of the guide protrusions 122 and 132 is formed from 0 to 50 degree, the guide protrusions 122 and 132 are smoothly moved at high velocity along the guide groove portion 152, thereby to improve the efficiency of the engine. Particularly, at the point E′ of operating the fuel explosion apparatus 140, when the angle θ between the tangent line T1 of the guide groove portion 152 and the moving direction T2 of the guide protrusions 122 and 132 is formed at 0 degree, all the straight line moving forces of the first piston 120 and the second piston 130 may be switched into the rotation forces of the rotation drum 150.

Further, FIG. 12 shows another example of the guide groove portion 152. The guide groove portions 152 of FIG. 12 have all characteristics included in the guide groove portions 152 of above-described FIG. 9 to 11. That is, like the guide groove portions of FIG. 9, the variation portions H1, H2, H3, and H4 of the guide groove portions 152 may be formed to have large curvatures in a narrow range, respectively. In addition, like the guide groove portions of FIG. 10, the variation portion H3 formed between the exhaust stroke C and the intake stroke D may be formed to be higher, in the direction of the top dead center(TDC), than the variation portion H1 formed between the compression stroke A and the expansion stroke B, and the variation portion H4 formed between the intake stroke D and the compression stroke A may be formed to be lower, in the direction of the bottom dead center(BDC), than the variation portion H2 formed between the expansion stroke B and the exhaust stroke C.

Further, FIG. 12 shows another example of the guide groove portions 152. The guide groove portions 152 of FIG. 1 have all characteristics included in the guide groove portion 152 of above-described FIG. 9 to 11. That is, like the guide groove portions of FIG. 9, the variation portions H1, H2, H3, and H4 of the guide groove portions 152 may be formed to have large curvatures in a narrow range, respectively. Further, like the guide groove portion shown in FIG. 10, the variation portion H3 formed between the exhaust stroke C and the intake stroke D may be formed to be higher, in the direction of the top dead center, than the variation portion

H1 formed between the compression stroke A and the expansion stroke B, and the variation portion H4 formed between the intake stroke D and the compression stroke A may be formed to be lower, in the direction of the bottom dead center, than the variation portion H2 formed between the expansion stroke B and the exhaust stroke C. However, the guide groove portions 152 shown in FIG. 11 are formed so that, at the point E and E′ of operating the fuel explosion apparatus 140, the angle θ between a tangent line T1 of the guide groove portions 152 and the moving direction T2 of the guide protrusions 122 and 132 is formed from 0 to 50 degree.

Hereinafter, it is described in the present embodiment that the guide groove portion 152 shown in FIG. 12 among the guide groove portions 152 shown in FIGS. 8 and 12 is formed in the rotation drum 150. Further, it is described in the guide groove portions 152 shown in FIG. 12 that, at the point E of operating the fuel explosion apparatus 140, the angle θ between the tangent line T1 of the guide groove portion 152 and the moving direction T2 of the guide protrusions 122 and 132 is formed at 45 degree. However, in the guide groove portions 152 shown in FIG. 12, the angle between the tangent line of the guide groove portions 152 and the moving direction of the guide protrusions 122 and 132 may be formed at 0 degree at the point E of operating the fuel explosion apparatus 140 according to design conditions and situations of the crankless engine 100.

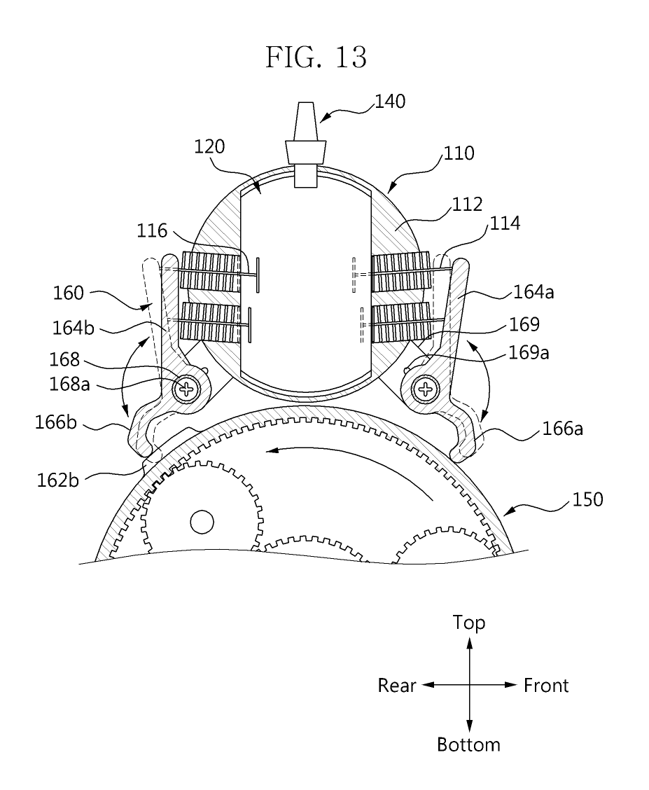

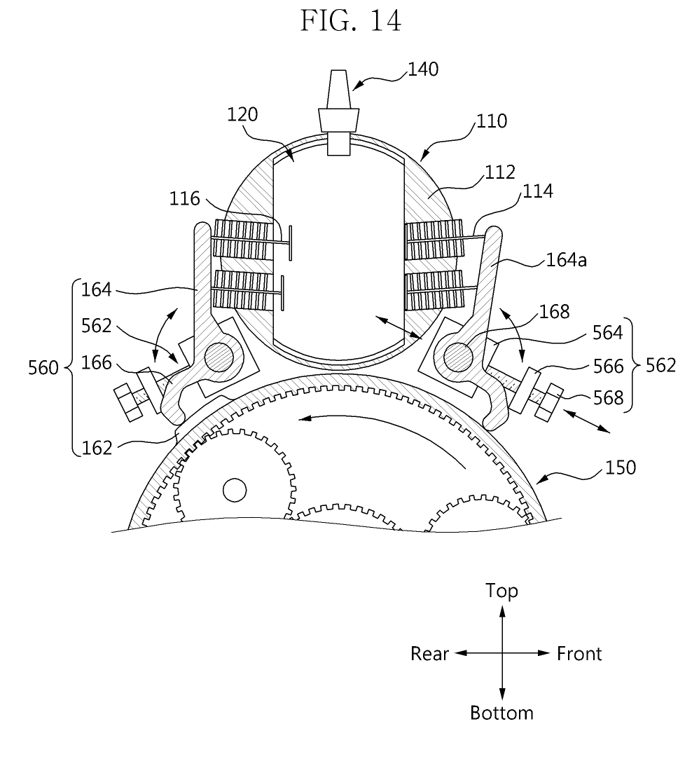

FIG. 13 is an operating state view representing one example of a valve opening/closing device shown in FIG. 1, and FIGS. 14 to 16 are operating state views representing another example of a valve opening/closing device shown in FIG. 13, respectively.

Referring to FIGS. 2, 3 and 13, the valve opening/closing device 160 opens/closes the exhaust valve 116 and the intake valve 114 according to the rotation angle of the rotation drum 150. The valve opening/closing device 160 may automatically opens/closes the exhaust valve 116 and the intake valve 114 using the rotation forces F of the rotation drum 150 at optimal times. Therefore, a timing belt and a cam axis etc. used in the reciprocal piston engine in the related art are unnecessary.

The valve opening/closing device 160 may be disposed in the outer periphery of the cylinder 110. However, the valve opening/closing device 160 may be disposed in another components capable of not moving according to the design conditions and situations of the crankless engine 100. For example, the valve opening/closing device 160 may be disposed in the engine case(not shown) accommodating the cylinder 110 and the rotation drum 150 into the inside thereof, but the description about it in the present embodiment is omitted.

The valve opening/closing device may include a drum protrusion portion 162, a valve opening/closing portion 164 and an opening/closing adjustment portion 166.

The drum protrusion portion 162 is a protrusion protruded from the outer periphery of the rotation drum 150. The drum protrusion portion 162 may include an intake drum protrusion portion 162a and an exhaust drum protrusion portion 162b disposed in the position different from each other in the rotation drum 150. The intake drum protrusion portion 162a and the exhaust drum protrusion portion 162b may be formed plurally along the circumference direction in the outer periphery of the rotation drum 150. Further, the intake drum protrusion portion 162a and the exhaust drum protrusion portion 162b may be formed in the position different from each other in the circumference direction of the rotation drum 150 according to the opening/closing point of the intake valve 114 and the exhaust valve 116. Further, the intake drum protrusion portion 162a and the exhaust drum protrusion portion 162b may be disposed in the rotation drum 150, and adjust the positions in the circumference direction of the rotation drum 150. Like this, when adjusting the positions of the intake drum protrusion portion 162a and the exhaust drum protrusion portion 162b, it is possible to freely adjust the opening/closing point and the opening/closing maintaining period of the valve.

The end portion of the exhaust valve 116 or the intake valve 114 is disposed with one side of the valve opening/closing portion 164 opening/closing the exhaust valve 116 or the intake valve 114. The valve opening/closing portion 164 may be rotatably disposed as a hinge structure with respect to the outside of the cylinder 110 or the engine case. The valve opening/closing portion 164 may include an intake valve opening/closing portion 164a opening/closing the intake valve 114 and an exhaust valve opening/closing portion 164b opening/closing an exhaust valve 116.

The rotation axis 168 of the valve opening/closing portion 164 may be disposed to optionally adjust the opening/closing point of the intake valve 114 and the exhaust valve 116 so that the position thereof may be adjusted in the engine case(not shown) or the cylinder 110 of the crankless engine 100. The position of the valve opening/closing portion 164 may be changed along the outer periphery of the rotation drum 150. Therefore, when using the crankless engine 100 for a long time, in a case where timing of the intake valve 114 deviates from that of the exhaust valve 116, the timing of the intake valve 114 and the exhaust valve 116 may be simply adjusted by changing the position of the rotation axis 168 of the valve opening/closing portion 164.

For example, a bracket 169 supporting the rotation axis 168 may be protruded from the cylinder 110, a hole 169a penetrated with the rotation axis 168 may be formed lengthily in the same or similar direction as that of the outer periphery surface of the rotation drum 150 in the bracket 169, and a fastening device (168a) fastening the rotation axis 168 to a specific position of the hole 169a may be disposed in the bracket 169 and the rotation axis 168. As described above, the timings of the intake valve 114 and the exhaust valve 116 may be more freely adjusted by changing the position of the intake drum protrusion portion 162a and the exhaust drum protrusion portion 162b together in the circumference direction of the rotation drum.

The opening/closing adjustment portion 166 opens/closes the intake valve 114 or the exhaust valve 116 by rotating the valve opening/closing portion 164 by the drum protrusion portion 162 at the time of rotating the rotation drum 150. The opening/closing adjustment portion 166 may be formed as an opening/closing adjustment protrusion 166 protruded from the outer periphery of the rotation drum 150 in the other side of the valve opening/closing portion 164.

The opening/closing adjustment protrusion 166 may be formed integrally in the other side of the valve opening/closing portion 164. The end portion of the opening/closing adjustment protrusion 166 contacts or is adjacent to the outer periphery of the rotation drum 150, and may rotate the valve opening/closing portion 164 while getting over the drum protrusion 162 when rotating the rotation drum 150. The opening/closing adjustment protrusion 166 may include an intake opening/closing adjustment protrusion 166a formed in the other side of the intake valve opening/closing portion 164a and interfering with the intake drum protrusion portion 162a, and an exhaust opening/closing adjustment protrusion 166b formed in the other side of the exhaust valve opening/closing portion 164b and interfering with the exhaust drum protrusion portion 162b.

Meanwhile, FIG. 14 shows another example of the valve opening/closing device 560. Referring to FIG. 14, the valve opening/closing device 560 may include the drum protrusion portion 162, the valve opening/closing portion 164, the opening/closing adjustment portion 166, and the position adjustment portion 562. That is, when comparing with the valve opening/closing device 160 shown in FIG. 13, it is different in that the valve opening/closing device 560 shown in FIG. 14 includes the position adjustment portion 562 without having the bracket 169 and the fastening device 168a shown in FIG. 13. Therefore, hereinafter, the position adjustment portion 562 only is described, but the detailed description for the elements except it is omitted.

For example, the position adjustment portion 562 may include a moving block 564, a fixing bracket 566, and an adjustment screw 568. That is, the moving block 564 may be movably disposed in the engine case in the same or similar direction as that of the outer periphery of the rotation drum 150, the fixing bracket 566 may be fixed in the engine case to be spaced at a predetermined distance from the moving block 564, and the adjustment screw 568 may be movably fastened to the fixing bracket 566 so that the end portion thereof contacts the moving block 564. At this time, the moving block 564 may be elastically supported toward the adjustment screw 568, and the rotation axis 168 of the valve opening/closing portion 164 may be rotatably disposed. Therefore, when rotating the adjustment screw 568, the position of the moving block 564 is moved according to the position change of the adjustment screw 568, such that the position of the valve opening/closing portion 164 may be also adjusted.

However, the elements of the position adjustment portion 562 are not limited to above-described elements, and various elements may be applied according to the design conditions and situations of the engine. For an example, it is also possible to adjust the position of the valve opening/closing portion 164 using an actuator or an electric motor.

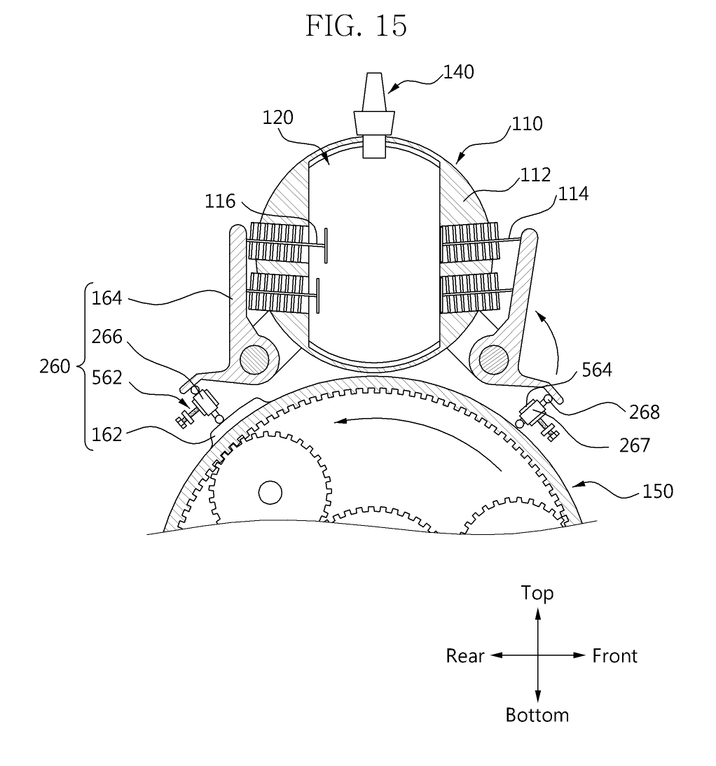

Meanwhile, FIG. 15 shows another example of the valve opening/closing device 260. Referring to FIG. 15, the valve opening/closing device 260 may include the drum protrusion portion 162, the valve opening/closing portion 164, the opening/closing adjustment portion 266, and the position adjustment portion 562. That is, when comparing with the valve opening/closing device 560 shown in FIG. 14, it is different in that the valve opening/closing device 260 shown in FIG. 15 includes the opening/closing adjustment portion 266. Therefore, hereinafter, the opening/closing adjustment portion 266 only is described, but the detailed description for the elements except it is omitted.

The opening/closing adjustment portion 266 shown in FIG. 15 includes a moving guide 267 disposed between the valve opening/closing portion 164 and the rotation drum 150, and an opening/closing adjustment rod 268 disposed movably with respect to the moving guide 267 and disposing the both end thereof in the other side of the valve opening/closing portion 164 and the outer periphery of the rotation drum 150. The inside of the moving guide 267 may be formed as a cylindrical shape formed with the hollow portion. The hollow portion of the moving guide 267 may be disposed with the middle portion of the opening/closing adjustment rod 268 that may move in the radius direction of the rotation drum 150. The moving guide 267 may be disposed in the moving block 564 of the position adjustment portion 562. The opening/closing adjustment portion 266 may include an intake opening/closing adjustment portion disposed between the intake valve opening/closing portion 164a and the intake drum protrusion portion 162a, and an exhaust opening/closing adjustment portion disposed between the exhaust valve opening/closing portion 164b and the exhaust drum protrusion portion 162b.

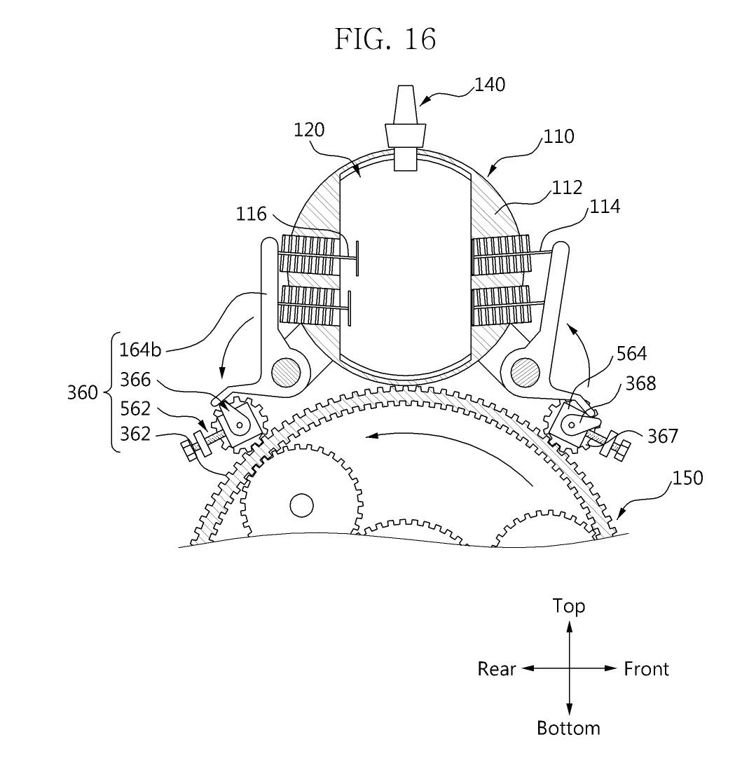

Further, FIG. 16 shows another example of the valve opening/closing device 360. Referring to FIG. 16, the valve opening/closing device 360 shown in FIG. 16 may include the drum protrusion portion 362, the valve opening/closing portion 164, the opening/closing adjustment portion 366, and the position adjustment portion 562. That is, when comparing with the valve opening/closing device 560 shown in FIG. 14, it is different in that the valve opening/closing device 360 shown in FIG. 16 includes the drum protrusion portion 362 and the opening/closing adjustment portion 366. Therefore, hereinafter, the drum protrusion portion 362 and the opening/closing adjustment portion 366 only are described, but the detailed description for the elements except them is omitted.

The drum protrusion portion 362 shown in FIG. 16 may be formed in a gear shape along the circumference direction in the outer periphery of the rotation drum 150. Meanwhile, in the present embodiment, although it is described that a single drum protrusion portion 362 is commonly used for two opening/closing adjustment portion 366, two drum protrusion portion 362 corresponding to two opening/closing adjustment portion 366, as necessary, may be formed.

The opening/closing adjustment portion 366 shown in FIG. 16 may include a cam gear 367 coupled with the drum protrusion portion 362, and an opening/closing adjustment cam 368 disposed in the rotation axis 168 of the cam gear and slidably contacting in the other side of the valve opening/closing portion 164. When rotating the rotation drum 150, the cam gear 367 may be rotated together with the drum protrusion portion 362. The opening/closing adjustment cam 368 rotates together with the cam gear 367, to rotate the valve opening/closing portion 164. The rotation axis of the cam gear 367 and the opening/closing adjustment cam 368 may be rotatably disposed in the moving block 564 of the position adjustment portion 562. The opening/closing adjustment portion 366 may include an intake opening/closing adjustment portion disposed between the intake valve opening/closing portion 164a and the intake drum protrusion portion 162a, and an exhaust opening/closing adjustment portion disposed between the exhaust valve opening/closing portion 164b and the exhaust drum protrusion portion 162b.

Further, in the valve opening/closing device of the present embodiment, the intake valve 114 and the exhaust valve 116 are formed as a solenoid valve, thereby to adjust the operating timing of the valve by electron control method according to the rotation velocity of the engine. In addition, the method adjusting the position of the valve opening/closing portion 164 and the opening/closing adjustment portion 266 and 366 is also limited to above-described examples, and various methods may be applied according to the design conditions and situations.

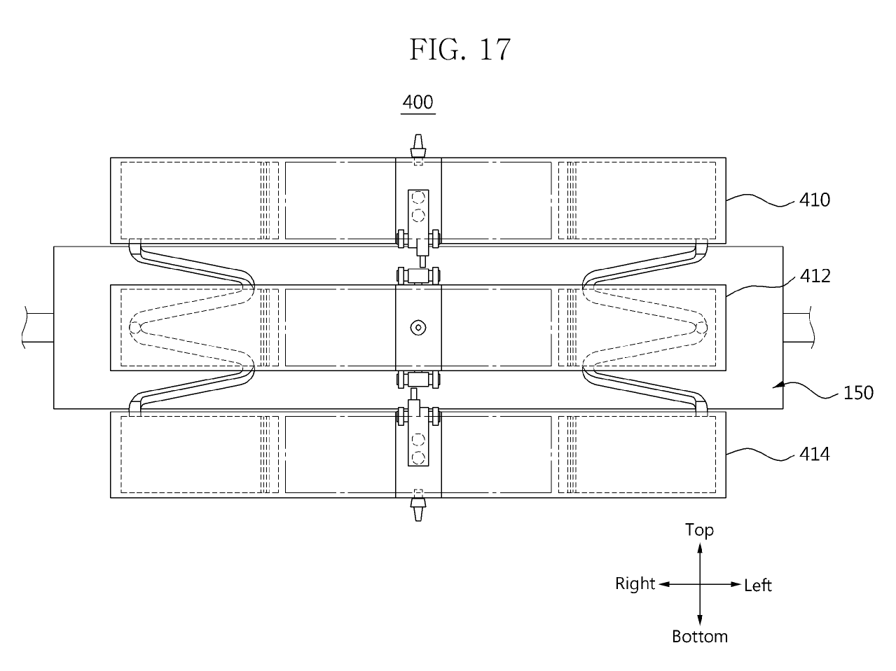

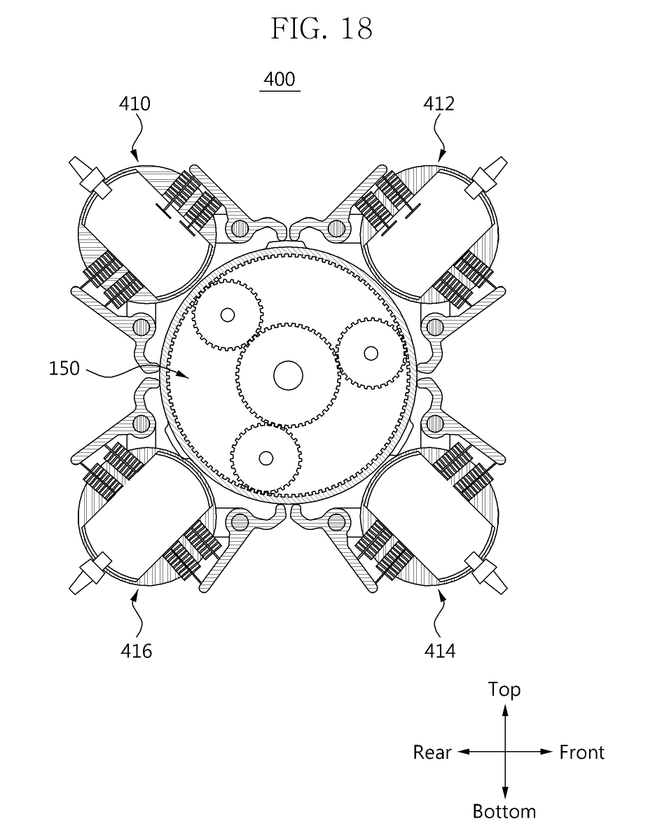

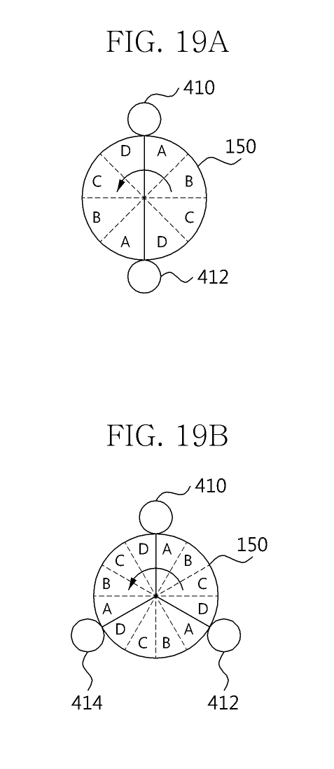

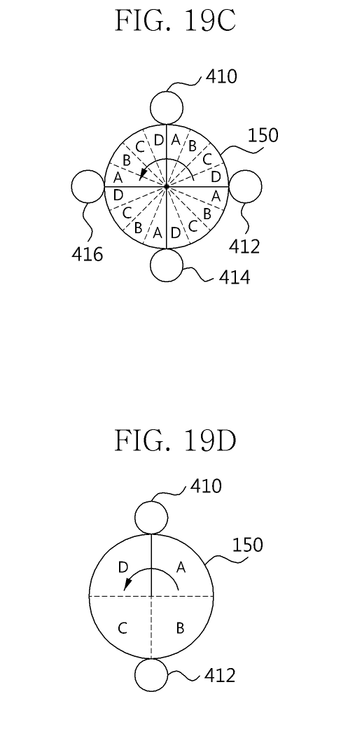

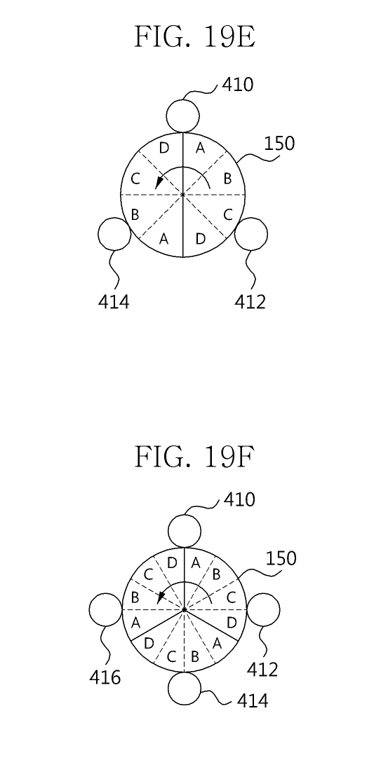

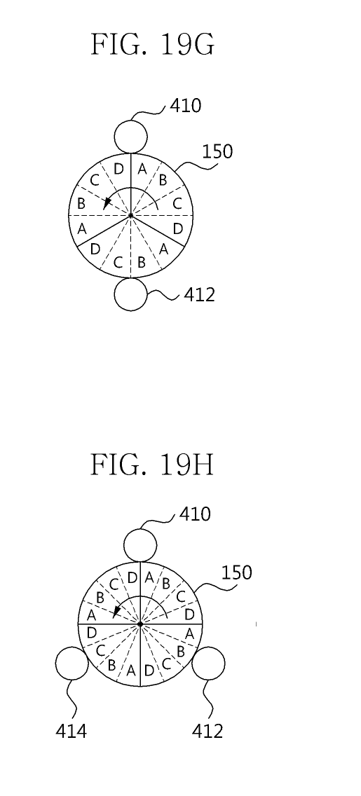

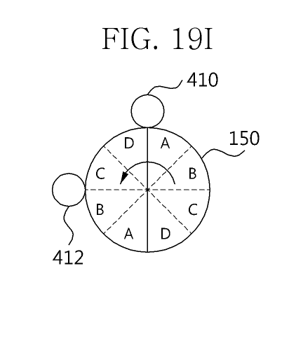

FIG. 17 is a front view shown with the crankless engine according to another embodiment of the invention, and FIG. 18 is a view representing a section of the crankless engine showed in FIG. 17. Further, FIG. 19 is a schematic view representing various structures of the guide groove portions according to the number of the cylinder in another embodiment of the invention. Like reference numerals between FIGS. 17 to 19 and FIGS. 1 and 2 refer to like elements. Hereinafter, different content between the crankless engines shown in FIGS. 1 and 2 and FIGS. 17 to 19 is described.

Referring to FIGS. 17 and 19, the crankless engine 400 according to another embodiment of the invention includes an engine bodies 410, 412, 414 and 416 having the cylinder 110, the first piston 120, the second piston 130, the fuel explosion device 140, and the valve opening/closing device 160, and the engine bodies 410, 412, 414 and 416 are disposed plurally in a single rotation drum 150, unlike the crankless engine 100 shown in FIGS. 1 and 2.

That is, the engine bodies 410, 412, 414 and 416 may be spaced apart from each other at random intervals along the circumference direction in the outer periphery of the rotation drum 150. Since all the engine bodies 410, 412, 414 and 416 are disposed in a single rotation drum 150, the rotation drum 150 may be commonly used, and therefore, although the number of the cylinder of the engine is increased, thereby to relatively greatly not increase a appearance size of the engine.

The engine bodies 410, 412, 414 and 416 may be disposed in a plurality of positions along the length direction of the rotation drum 150. When the engine bodies 410, 412, 414 and 416 may be disposed in the positions to be spaced apart from each other in the length direction of the rotation drum 150, each of the guide groove portions 152 may be also disposed in the positions to be spaced apart from each other in the length direction of the rotation drum 150. In addition, the number of the cylinder for the engine may be simply increased by only increasing the length of the rotation drum 150.

The guide groove portions 152 may be formed by the same number as that of the engine bodies 410, 412, 414 and 416. A plurality of guide groove portions 152 may be formed in the shape connected to each other along the circumference in the rotation drum 150. As above, when guide groove portions 152 may be formed, all the engine bodies 410, 412, 414 and 416 perform the same stroke regardless of the positions.

Meanwhile, unlike the above, the guide groove portions 152 may be formed by the number larger or smaller than that of the engine bodies 410, 412, 414 and 416. The plurality of guide groove portions 152 may be formed in the shape connected to each other along the circumference direction in the rotation drum 150. As above, when guide groove portions 152 may be formed, all the engine bodies 410, 412, 414 and 416 perform the strokes different from each other according to the positions. Therefore, when the crankless engine 400 is formed by a plurality of the number of the cylinder, each of the engine bodies 410, 412, 414 and 416 generate the rotation forces F at points different from each other to more consecutively secure the power of the crankless engine 400.

On describing FIG. 19 in more detail, elements of the crankless engine 400 are schematically shown as the engine bodies 410, 412, 414 and 416 and the number of the guide groove portions 152 in FIG. 19.

Like FIG. 19A-19C, when the numbers of the engine bodies 410, 412, 414 and 416 and the guide groove portions 152 are the same, all the engine bodies 410, 412, 414 and 416 perform the same stoke. However, like FIG. 19I, when the numbers of the engine bodies 410, 412, 414 and 416 and the guide groove portions 152 are the same and the engine bodies 410 and 412 are spaced at the angle different from each other, the engine bodies 410 and 412 perform the strokes different from each other.

Further, Like FIG. 19D-19F, when the number of the engine bodies 410, 412, 414 and 416 is larger by one than the number of the guide groove portions 152, the engine bodies 410, 412, 414 and 416 perform the stoke different from each other. Further, Like FIG. 19G-19H, when the number of the engine bodies 410, 412 and 414 is smaller by one than the number of the guide groove portions 152, the engine bodies 410, 412 and 414 perform the stoke different from each other.

As above, when the numbers of the engine bodies 410, 412, 414 and 416 and the guide groove portions 152 are not the same (FIG. 19D-19H), the engine bodies 410, 412, 414 and 416 may sequentially perform the strokes different from each other, and therefore, it is preferable, than having the same number between them, that the numbers of the engine bodies 410, 412, 414 and 416 and the guide groove portions 152 are not the same.

Further, when although the numbers of the engine bodies 410 and 412 and the guide groove portions 152 are the same and the engine bodies 410 and 412 are spaced at the angle different from each other(FIG. 19D-19H), the engine bodies 410, 412, 414 and 416 may perform the strokes different from each other. Therefore, since the engine bodies 410 and 412 may be eccentrically disposed according to the design conditions and situations of the engine, the degree of freedom for the design of the engine may be improved.

Further, when the number of the engine bodies 410, 412, 414 and 416 is larger by one than the number of the guide groove portions 152(FIG. 19D-19F) and the number of the engine bodies 410, 412, 414 and 416 is smaller by one than the number of the guide groove portions 152(FIG. 19G-19H), the engine bodies 410, 412, 414 and 416 may sequentially perform the strokes different from each other, thereby to perform the same or similar performance by the engine in the case of two mentioned above. However, the case, that the number of the engine bodies 410, 412, 414 and 416 is larger by one than the number of the guide groove portions 152(FIG. 19D-19F), is relatively convenient to manufacture.

According to an embodiment of the invention configured as above, the operation of the crankless engine 100 is described as follows.

The crankless engine 100 repeatedly perform four strokes consisting of an intake stroke (D), a compression stroke(A), an expansion stroke(B), and an exhaust stroke(C).

Referring to FIGS. 4 and 12, in the intake stroke (D), the first piston 120 is moved to the left, and the second piston 130 is moved to the right. Further, the intake valve 114 is in opened state, and the exhaust valve 116 is in closed state.

At this time, since the first piston 120 and the second piston 130 are moved further than the bottom dead center (BDC) in the direction away from the intake and exhaust portion 112, the size of the operating space becomes at its maximum. Therefore, the intake amount of the fuel gas suctioned through the intake valve 114 is greatly increased, and therefore, the intake efficiency of the crankless engine 100 may be improved.

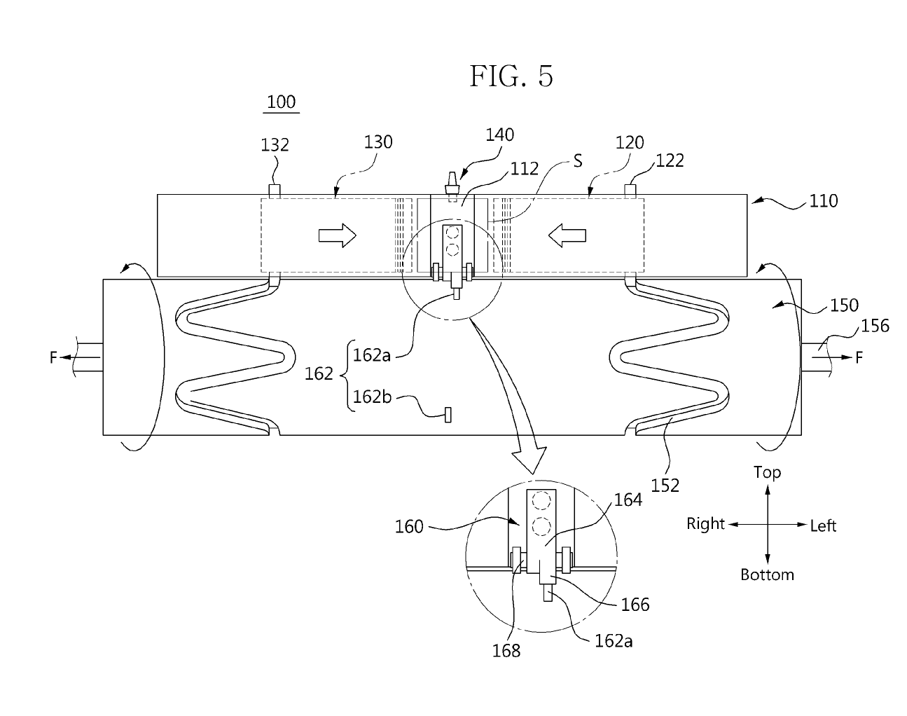

Referring to FIGS. 5 and 12, in the compression stroke (A), the first piston 120 is moved to the right, and the second piston 130 is moved to the left. Further, all of the intake valve 114 and the exhaust valve 116 are in closed state.

At this time, the intake amount of the fuel gas suctioned by the intake stroke (D) is increased, and therefore, it is possible to improve the maximum compression pressure due to the increase of the fuel gas compressed by the compression stroke (A). Therefore, when combusting the fuel gas, perfect combustion for the fuel gas may be performed.

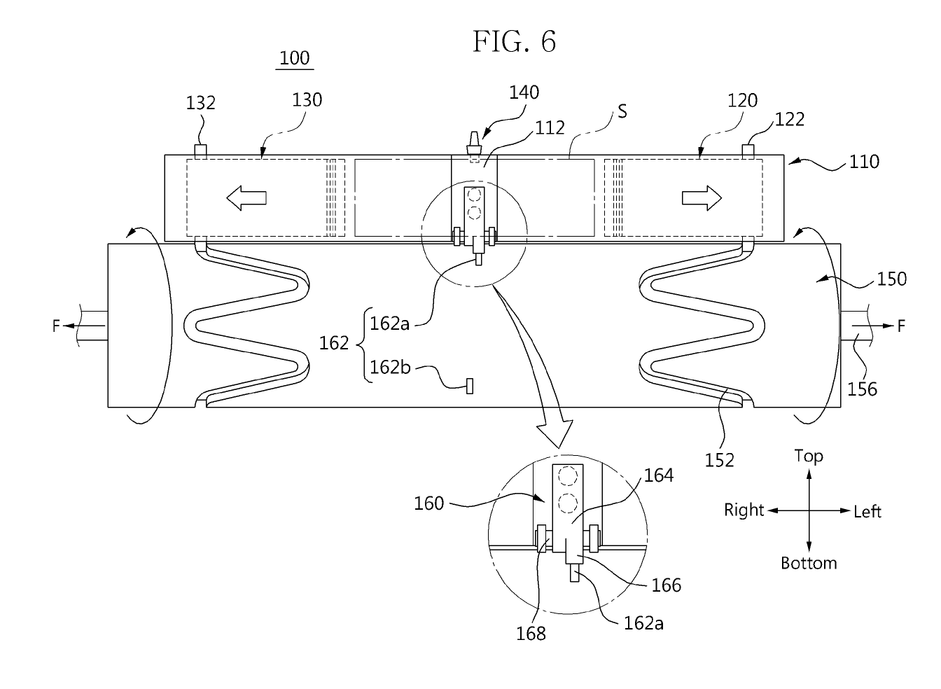

Referring to FIGS. 6 and 12, in the explosion stroke (B), the first piston 120 is moved to the left, and the second piston 130 is moved to the right. Further, all of the intake valve 114 and the exhaust valve 116 are in closed state. At this time, explosion forces of the fuel gas may be transmitted to all of the first piston 120 and the second piston 130.

Meanwhile, in the beginning of the explosion stroke (B), the fuel explosion device 140 is operated at the point slightly delayed from the point (E) to allow the size of the operating space (S) to become smaller at its minimum, thereby to explode the fuel gas within the operating space (S). The operation point (E) of the fuel explosion device 140 is slightly delayed because it is advantageous to operate the fuel explosion device 140 after being slightly moving from a peak of the variation portion (H1) of the guide groove portion 152.

Referring to FIGS. 6 and 13, in the exhaust stroke (C), the first piston 120 is moved to the right, and the second piston 130 is moved to the left. Further, the intake valve 114 is in closed state, and the exhaust valve 116 is in opened state.

At this time, since the first piston 120 and the second piston 130 are moved further than the top dead center (TDC) in the direction approaching from the intake and exhaust portion 112, the size of the operating space becomes at its minimum. Therefore, the remaining amount of the exhaust gas exhausted through the exhaust valve 116 is greatly decreased, and therefore, the exhaust efficiency of the crankless engine 100 may be improved.

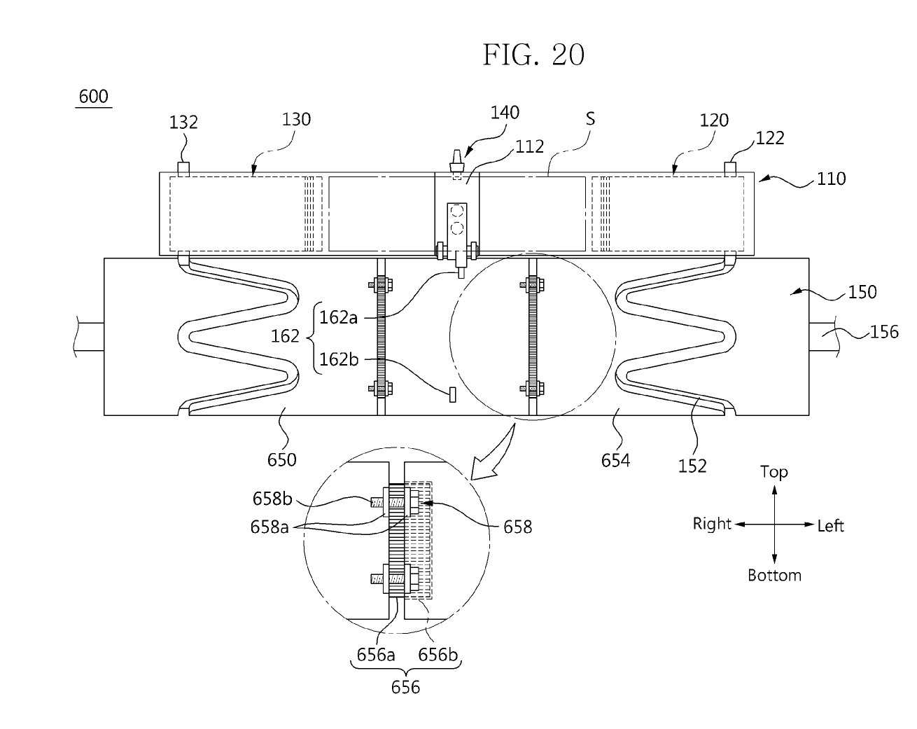

FIG. 20 is a front view shown with the crankless engine according to another embodiment of the invention. Like reference numerals between FIG. 20 and FIGS. 1 to 13 refer to like elements. Hereinafter, different content between the crankless engines shown in FIGS. 1 to 13 and FIG. 20 is described.

Unlike the crankless engines 100 shown in FIGS. 1 to 13, it is possible to adjust the length of the rotation drum 150 in the crankless engines 600 shown in FIG. 20.

For example, the rotation drum 150 may include body portions 650, 652 and 654 separated in the axis direction of the rotation drum 150, a combination portion 656 restricting the body portions 650, 652 and 654 in the rotation direction and movably combining the body portions 650, 652 and 654 in the axis direction of the rotation drum 150, and a fastening portion 658 restricting the body portions 650, 652 and 654 in the axis direction of the rotation drum 150.

Here, in the present embodiment, three body portions 650, 652 and 654 are configured so that body portions 650, 652 and 654 disposed in the left and the right of the rotation drum 150 may be moved side to side, but are not limited thereto, and it is also possible to configure, for example, two, four and five body portions according to the design conditions and situations.

Further, the combination portion 656 may include a combination protrusion 656a formed to be protruded from side of any one of the body portions 650, 652 and 654, and a combination groove 656b formed in the other side corresponding to the combination protrusion 656a of the body portions 650, 652 and 654. The combination protrusion 656a may be protruded in the cylindrical shape from the side of the body portions 650, 652 and 654. The outer periphery of the combination protrusion 656a may be formed with the gear, formed plurally in the circumference direction, formed lengthily in the axis direction of the rotation drum 150. The combination groove 656b may be formed in the shape so that the combination protrusion 656a may be inserted into the side of the body portions 650, 652 and 654. The inner periphery of the combination protrusion 656b may be formed with the gear combining the gear of the combination protrusion 656a, formed plurally in the circumference direction, formed lengthily in the axis direction of the rotation drum 150. Therefore, the rotation drum 150 may be widened or narrowed side to side around the combination portion between the combination protrusion 656a and the combination groove 656b. However, the combination portion 656 is not limited to the combination protrusion 656a and the combination groove 656b, and various structures that movably combine the body portions 650, 652 and 654 in the axis direction of the rotation drum 150 according to the design conditions and situations may be applied.

Further, the fastening portion 658 may include fastening flanges 658a facing each of the body portions 650, 652 and 654, and a fastening member 658b fastened to the fastening flanges 658a and fixing the body portions 650, 652 and 654. However, the fastening portion 658 is not limited to the fastening flanges 658a and the fastening member 658b, and various structures may be applied according to the design conditions and situations.

As above, when the length of the rotation drum 150 is adjusted in the axis direction, the position of the guide groove portion 152 is changed, and therefore, the position of the first piston 120 and the second piston 130 may be also changed. That is, when the length of the rotation drum 150 becomes short, a gap between the first piston 120 and the second piston 130 is reduced, thereby to reduce the size of the operating space S. On the other hand, when the length of the rotation drum 150 becomes long, a gap between the first piston 120 and the second piston 130 is increased, thereby to increase the size of the operating space S. Therefore, the performance of the crankless engine may be effectively changed by adjusting the length of the rotation drum 150.

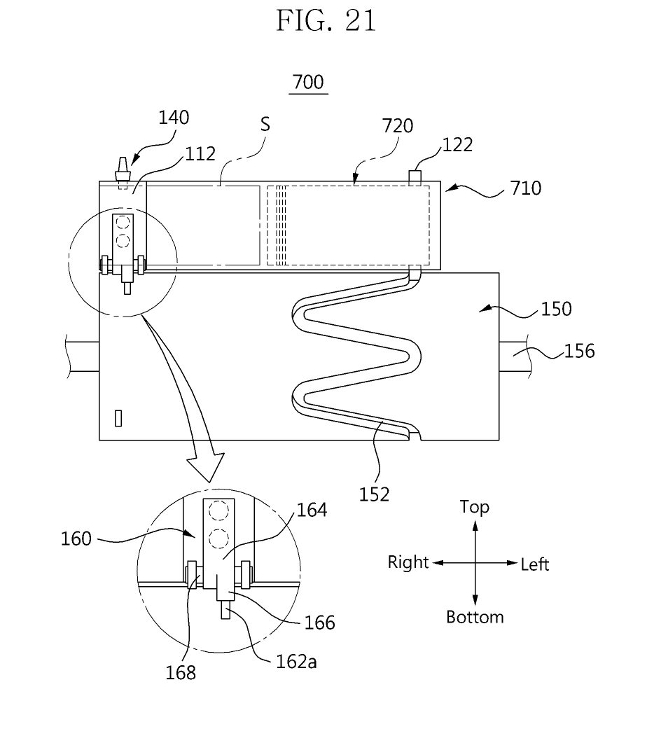

FIG. 21 is a front view shown with the crankless engine according to another embodiment of the invention. Like reference numerals between FIG. 21 and FIGS. 1 to 13 refer to like elements. Hereinafter, different content between the crankless engines shown in FIGS. 1 to 13 and FIG. 21 is described.

Unlike the crankless engines 100 shown in FIGS. 1 to 13, it is different to include the rotation drum 150 having a single cylinder 710 and piston 720 only in the crankless engines 700 shown in FIG. 21.

Therefore, unlike the crankless engines 100 shown in FIGS. 1 to 13, the crankless engines 700 shown in FIG. 20 may be applied to a small engine that does not need two pistons 120 and 130.

It is appreciated that the present invention can be carried out in other specific forms without changing a technical idea or essential characteristics by one having ordinary skilled in the art to which the present invention pertains to. Therefore, embodiments described above are for illustration purpose in all respect but not limited to them. The scope of the present invention is represented by claims described below rather than the detailed description, and any change and variations derived from the meaning, the scope and the concept of equality of claims should be interpreted to be included to the scope of the present invention.

### INDUSTRIAL APPLICABILITY

An industrial applicability is included in the description of the present application.

1. A crankless engine, comprising:
a cylinder formed halfway with an intake and exhaust portion disposed with an intake valve and an exhaust valve;
a first piston to be reciprocally movable in one side of the cylinder;
a second piston to be reciprocally movable in the other side of the cylinder so that the first piston faces the second piston around the intake and exhaust portion;
a fuel explosion apparatus, disposed in the intake and exhaust portion, exploding the fuel in the inside of an operating space when the operating space formed among the cylinder, the first piston and the second piston is formed at its minimum; and
a rotation drum disposed in parallel with the cylinder, rotating by moving forces of the first piston and the second piston when the first piston and the second piston reciprocally move
wherein the first piston and the second piston are moved in the opposite direction from each other along the cylinder to simultaneously compress or expand the operating space.

2. The crankless engine according to claim 1, wherein the first piston and the second piston are formed with a guide protrusion protruded toward the rotation drum, one side and the other side of the cylinder are formed with the guide hole portion through which the guide protrusion is penetrated movably, and one side and the other side of the rotation drum is formed with guide groove portions to be movably inserted with an end portion of the guide protrusion so that the moving forces of the first piston and the second piston are switched into the rotation forces of the rotation drum.

3. The crankless engine according to claim 2, wherein the first piston and the second piston are formed to be not exposed with the guide hole portion in the operating space when the first piston and the second piston move.

4. The crankless engine according to claim 2, wherein the plurality of guide protrusions are formed to be spaced away from each other at random angles along circumferential direction in an outer periphery of the piston, and the plurality of guide hole portions are formed in the positions to be faced with the guide protrusions.

5. The crankless engine according to claim 2, wherein the guide hole portion guiding the moving of the first piston and the second piston is formed lengthily along the moving directions of the first piston and the second piston in the same width as that of the thickness of the guide protrusion.

6. The crankless engine according to claim 2, wherein the guide groove portions are formed in at least one looped curve of a sine wave or a deformed sine wave along the circumferential direction in the outer periphery of the rotation drum so that the rotation drum may be rotated by the guide protrusions when the first piston and the second piston reciprocally move.

7. The crankless engine according to claim 6, wherein the end portions of the guide protrusions are moved along a single cycle groove portion when one cycle operates in the crankless engine, and the guide groove portions are formed in a shape connecting the plurality of cycle groove portions along the circumferential direction in the outer periphery of the rotation drum.

8. The crankless engine according to claim 6, wherein each of the variation portions of the guide groove portions are formed to have large curvatures in a range narrower than the range of the variation portion of the sine wave so as to switch the moving direction of the first piston and the second piston quickly.

9. The crankless engine according to claim 6, wherein the crankless engine is one cycle engine with four strokes, and each of the variation portions of the guide grooves portion are formed in positions different from each other so that the operating space is formed at a maximum in a intake stroke and the operating space is formed at a minimum in a exhaust stroke.

10. The crankless engine according to claim 6, wherein the guide grooves portions are formed so that, at the point of operating the fuel explosion apparatus, an angle between a tangent line of the surface contacting the guide protrusion and the moving direction of the guide protrusion is formed from 0 to 50 degree.

11. The crankless engine according to claim 1, wherein the insides of the intake and exhaust portion are formed by hollow shapes, and the insides of the intake and exhaust portion are formed by sectional areas smaller than those of the cylinder.

12.-17. (canceled)

18. The crankless engine according to claim 1 wherein the fuel explosion device includes a fuel injection device injecting fuel gas into the inside of the operating space at the point that the size of the operating space is at its minimum, and at the point that the size of the operating space is at its minimum, the air in the operating space is compressed to be a temperature naturally igniting the fuel gas.

19. The crankless engine according to claim 1, wherein the fuel explosion device includes a fuel ignition device igniting the fuel gas in the inside of the operating space at the point that the size of the operating space is at its minimum, and at the time that the size of the operating space is at its minimum, the fuel gas and air in the operating space are compressed to be a pressure perfectly combusting the fuel gas.

20. The crankless engine according to claim 1, wherein the insides of the rotation drum is formed by hollow shapes, and the insides of rotation drum is formed with a transmission power portion powering to the outside after transmitting the rotation forces of the rotation drum.

21. The crankless engine according to claim 20, wherein the transmission power portion includes a planetary gear set decelerating a rotational velocity of the rotation drum.

22. The crankless engine according to claim 2, wherein a length of the rotation drum may be adjusted in axial direction so as to change the position of the guide groove portions.

23. The crankless engine according to claim 2, wherein the plurality of cylinders are formed to be spaced away from each other at random intervals along circumferential direction in an outer periphery of the rotation drum.

24. The crankless engine according to claim 23, wherein the guide groove portions are formed by the same number as that of the cylinders, and the rotation drum is formed with the guide groove portions connecting with each other along the circumferential direction thereof.

25. The crankless engine according to claim 23, wherein the guide groove portions are formed by the number greater than or less than that of the cylinders, and the rotation drum is formed with the guide groove portions connecting with each other along the circumferential direction thereof.

26. The crankless engine according to claim 23, wherein the cylinders are disposed in the plurality of positions to be spaced along the length direction of the rotation drum, and each of the guide groove portions are formed at the outer periphery of the rotation drum corresponding to the cylinders.

27. The crankless engine according to claim 1, wherein the crankless engine is disposed in the cylinder or the an engine case, and further includes a valve opening/closing device adjusting opening/closing of the intake valve and the exhaust valve according the rotational angle of the rotation drum.

28. The crankless engine according to claim 27, wherein the valve opening/closing device includes
a drum protrusion portion protruded from the outer periphery of the rotation drum;
a valve opening/closing portion rotatably disposed in the outside of the cylinder and the engine case and disposing one side thereof in the end portion of the exhaust valve or the end portion of the intake valve; and
an opening/closing adjustment portion disposed between the other side of the valve opening/closing portion and the drum protrusion portion and opening/closing the intake valve or the exhaust valve by rotating the valve opening/closing portion at the time of rotating the rotation drum.

29. The crankless engine according to claim 28, wherein at least one of the valve opening/closing portion or the opening/closing adjustment portion is disposed, so that the position thereof may be changed in the cylinder or the engine case, so as to adjust opening/closing point of the intake valve and the exhaust valve.

30. The crankless engine according to claim 28, wherein the drum protrusion portion includes an intake drum protrusion portion and an exhaust drum protrusion portion disposed in positions different from each other in the rotation drum, and the intake drum protrusion portion and the exhaust drum protrusion portion are formed plurally along circumferential direction in an outer periphery of the rotation drum.

31. The crankless engine according to claim 30, wherein the opening/closing adjustment portion is formed as an opening/closing adjustment protrusion protruded from the other side of the valve opening/closing portion so that the end thereof rotatably contacts the outer periphery of the rotation drum formed with the drum protrusion portion at the time of rotating the rotation drum.

32. The crankless engine according to claim 30, wherein the opening/closing adjustment portion includes
a moving guide disposed between the valve opening/closing portion and the rotation drum; and
an opening/closing adjustment rod, movably disposed in the moving guide, disposing the both end thereof in the other side of the valve opening/closing portion and the outer periphery of the rotation drum.

33. The crankless engine according to claim 30, wherein the drum protrusion portion includes an intake drum protrusion portion and an exhaust drum protrusion portion disposed in positions different from each other in the rotation drum, and the intake drum protrusion portion and the exhaust drum protrusion portion are formed in a gear shape along circumferential direction in an outer periphery of the rotation drum.

34. The crankless engine according to claim 33, wherein the opening/closing adjustment portion includes
a cam gear coupled with the drum protrusion portion; and
an opening/closing adjustment cam disposed in the rotational axis of the cam gear, and slidably contacting the other side of the valve opening/closing portion.
